(19) United States
(12) Patent Application Publication
(10) Pub. No.: US 2026/0281729 A1
(43) Pub. Date: Sep. 17, 2026

(54) SYSTEM AND METHOD FOR AUTHORIZING PRESENCE OF ENTITIES IN MONITORED ZONES

(71) Applicant: KAZEM JOHN LLC, Boynton Beach, FL (US)

(72) Inventor: Kazem J. Rezakhani, Boynton Beach, FL (US)

(21) Appl. No.: 19/430,677

(22) Filed: Dec. 23, 2025

Related U.S. Application Data
(63) Continuation-in-part of application No. 19/076,001, filed on Mar. 11, 2025, now Pat. No. 12,530,950.

(51) Int. Cl. H04W 12/64; G07C 9/27; G07C 9/28; H04L 9/40

(52) U.S. Cl. CPC H04W 12/64; G07C 9/27; G07C 9/28; H04L 63/0861; G07C 2209/08

(57) ABSTRACT

A system for authorizing presence of an entity in a zone is described. The system includes a monitoring system configured to transmit a credential authentication request upon detection of a triggering event associated with the entity. In absence of a response to the credential authentication request from a first electronic device associated with the entity within a predetermined time interval or a failure to authenticate the first electronic device based on a response to the credential authentication request or detection of a tampering event at the first electronic device, the monitoring system is configured to transmit a biometric authentication request to a second electronic device associated with the entity. The monitoring system is configured to authenticate the entity based on biometric data received in response to the biometric authentication request, authorize the presence of the entity upon the authentication, and deactivate a response device based on the authorization.

### CROSS-REFERENCE TO RELATED APPLICATIONS

The present application is a continuation-in-part of U.S. Non-Provisional Application No. 19/076,001, filed Mar. 11, 2025, entitled “SYSTEM AND METHOD FOR AUTHORIZING MOVEMENT OF ENTITIES IN MONITORED ZONES”, the disclosure of which is incorporated by reference herein in its entirety.

### BACKGROUND OF THE INVENTION

Oftentimes, for security purposes, motion detection and alarm systems are installed in or around different private areas or enclosures including, but not limited to, houses, government or military buildings or areas, or wildlife protection zones, parks, or areas. Conventional motion detection and alarm systems are configured to trigger an alert or an alarm in response to any movement of people, animals, or machines detected in a vicinity of such conventional motion detection and alarm systems. However, such a configuration may be undesirable since the movement of any individual, animal, or machine including those of identifiable entities such as, but not limited to, pets, members, or vehicles associated with the private enclosures, may cause the motion detection and alarm systems to needlessly and repeatedly trigger the alarm in some instances. Moreover, in instances where temporary access is granted to identifiable entities, such as service personnel entering a facility, it is essential to ensure that such entities do not remain within the private areas or enclosures beyond an authorized time window.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 illustrates an exemplary system for authorizing movement of at least one entity in at least one zone, in accordance with some embodiments;

FIG. 2 illustrates a block diagram of an exemplary detector for use within the system of FIG. 1, in accordance with some embodiments;

FIG. 3 illustrates a block diagram of an exemplary beacon for use within the system of FIG. 1, in accordance with some embodiments;

FIG. 4 illustrates a block diagram of an exemplary server for use within the system of FIG. 1, in accordance with some embodiments;

FIG. 5 illustrates a block diagram of an exemplary electronic device for use within the system of FIG. 1, in accordance with some embodiments;

FIGS. 6 and 7 illustrate exemplary scenarios for authorizing movement of the at least one entity within the at least one zone, in accordance with some embodiments;

FIG. 8 illustrates a method for authorizing movement of the at least one entity within the at least one zone, in accordance with some embodiments;

FIG. 9 illustrates another exemplary system for authorizing presence of at least one entity in at least one zone, in accordance with some embodiments;

FIG. 10 illustrates a block diagram of an exemplary tamper detector for use within the system of FIG. 9, in accordance with some embodiments;

FIG. 11 illustrates a block diagram of another exemplary server for use within the system of FIG. 9, in accordance with some embodiments;

FIG. 12 illustrates an exemplary scenario for authorizing presence of the at least one entity within the at least one zone by way of the system of FIG. 9, in accordance with some embodiments;

FIG. 13 illustrates a block diagram of a first electronic device for use within the system of FIG. 9, in accordance with some embodiments;

FIG. 14 illustrates a block diagram of a second electronic device for use within the system of FIG. 9, in accordance with some embodiments; and

FIG. 15 illustrates another exemplary method for authorizing presence of the at least one entity within the at least one zone, in accordance with some embodiments.

Skilled artisans will appreciate that elements in the figures are illustrated for simplicity and clarity and have not necessarily been drawn to scale. For example, the dimensions of some of the elements in the figures can be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the description with details that will be readily apparent to those of ordinary skill in the art having the benefit of the description herein.

### DETAILED DESCRIPTION OF THE INVENTION

In one aspect, a system for authorizing presence of at least one entity in at least one zone is described. The system includes at least one monitoring system including at least one detector, at least one beacon, at least one tamper detector, and a response device communicatively coupled to each other. The at least one monitoring system is configured to detect, via the at least one detector and at least one processor of the at least one monitoring system, an occurrence of a triggering event associated with the at least one entity and transmit, via the at least one beacon and the at least one processor, a credential authentication request in response to the occurrence of the triggering event. The triggering event includes one or more of: a geofence entry of the at least one entity within the at least one zone, an input received on a first electronic device associated with the at least one entity, or an expiration of a preset time interval for authorizing presence of the at least one entity in the at least one zone. The monitoring system is configured to periodically determine, via the at least one tamper detector and the at least one processor, tamper status of the first electronic device associated with the at least one entity, and, in absence of a response to the credential authentication request from the first electronic device within a predetermined time interval or a failure to authenticate the first electronic device based on a response to the credential authentication request or detection of a tampering event at the first electronic device based on the tamper status, trigger, via the at least one processor, a fallback authentication sequence to authorize the presence of the at least one entity in the at least one zone. Further, the monitoring system is configured to transmit, via the at least one beacon, a biometric authentication request as the fallback authentication sequence to authorize the presence of the at least one entity in the at least one zone. The system further includes at least one second electronic device associated with the at least one entity. The at least one second electronic device is configured to receive, via a transceiver, the biometric authentication request from the at least one monitoring system, obtain, via a user interface and a processor, biometric data of the at least one entity in response to the biometric authentication request, and transmit, via the transceiver, the biometric data of the at least one entity to the at least one monitoring system. The at least one monitoring system is further configured to receive, via the beacon, the biometric data of the at least one entity and authenticate, via the at least one processor, the at least one entity based on the received biometric data. Further, the at least one monitoring system is configured to authorize, via the at least one processor, the presence of the at least one entity for the preset time interval upon the authentication and deactivate, via the at least one processor, the response device based on the authorization.

In another aspect, a method for authorizing presence of at least one entity in at least one zone is described. The method includes detecting, via at least one detector and at least one processor of at least one monitoring system, an occurrence of a triggering event associated with the at least one entity and transmit, via at least one beacon and the at least one processor of the at least one monitoring system, a credential authentication request in response to the occurrence of the triggering event. The triggering event includes one or more of: a geofence entry of the at least one entity within the at least one zone, an input received on a first electronic device associated with the at least one entity, or an expiration of a preset time interval for authorizing presence of the at least one entity in the at least one zone. The method further includes periodically determining, via at least one tamper detector and the at least one processor of the at least one monitoring system, tamper status of the first electronic device associated with the at least one entity, and, in absence of a response to the credential authentication request from the first electronic device within a predetermined time interval or a failure to authenticate the first electronic device based on a response to the credential authentication request or detection of a tampering event at the first electronic device based on the tamper status, triggering, via the at least one processor, a fallback authentication sequence to authorize the presence of the at least one entity in the at least one zone. Further, the method includes transmitting, via the at least one beacon, a biometric authentication request as the fallback authentication sequence to authorize the presence of the at least one entity in the at least one zone, receiving, via a transceiver of at least one second electronic device associated with the at least one entity, the biometric authentication request from the at least one monitoring system, and obtaining, via a user interface and a processor of the at least one second electronic device, biometric data of the at least one entity in response to the biometric authentication request. The method further includes transmitting, via the transceiver of the at least one second electronic device, the biometric data of the at least one entity to the at least one monitoring system, receiving, via the beacon, the biometric data of the at least one entity, and authenticating, via the at least one processor, the at least one entity based on the received biometric data. Further, the method includes authorizing, via the at least one processor, the presence of the at least one entity for the preset time interval upon the authentication and deactivating, via the at least one processor, a response device of the at least one monitoring system based on the authorization.

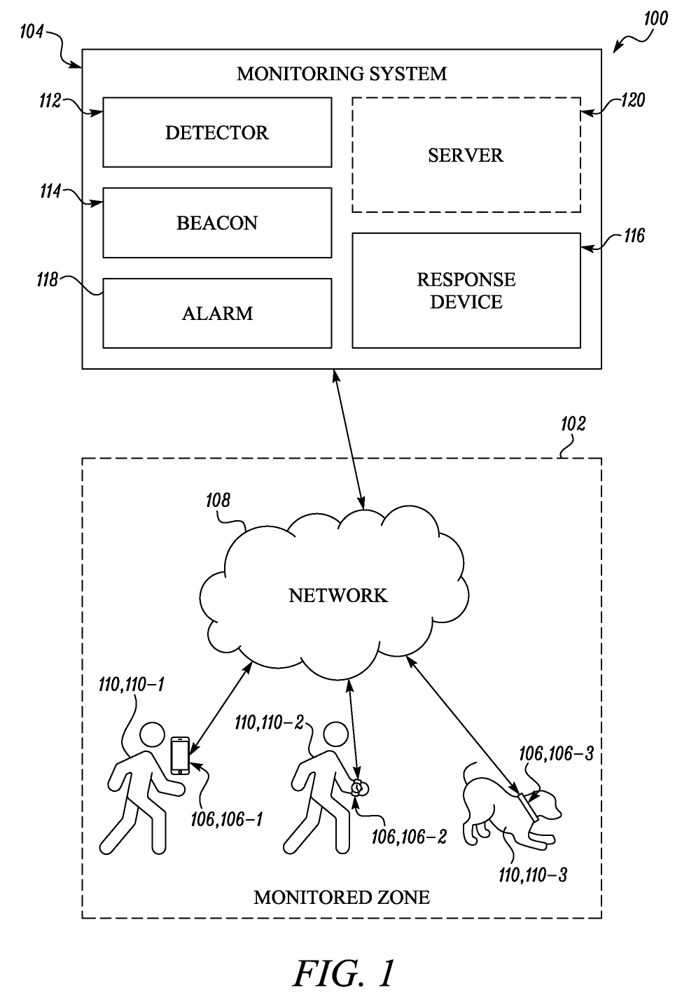

Referring to FIG. 1, an exemplary system 100 for authorizing movement of at least one entity 110 in at least one zone 102 is illustrated. The zone 102 corresponds to any designated area or space that is defined by a specific purpose, characteristics, or regulations. For example, the zone 102 includes one or more of a residential area (such as, but not limited to, a house, an apartment, and/or a surrounding area), a natural area (such as, but not limited to, a forest, or a wildlife reserve), a government area (such as, but not limited to, a military base, a government building, or an embassy), a public area (such as, but not limited to, a park, or a shopping mall), an industrial area (such as, but not limited to, a factory, an office or office building, or a warehouse), an agricultural area (such as, but not limited to a farmland), or any specialized area (such as, but not limited to, an airport or a border control zone). The entity 110 corresponds to at least one of a human, an animal, or a manually controlled or autonomous machine or vehicle or any other entity with motion now known or in the future developed.

The system 100 includes at least one monitoring system 104 and at least one electronic device 106 (for example, but not limited to, the electronic devices 106-1, 106-2, and 106-3). In accordance with various embodiments, each electronic device 106 is associated, for example, worn or attached to, the corresponding entity 110. For example, as illustrated, the electronic device 106-1 is associated with the entity 110-1, the electronic device 106-2 is associated with the entity 110-2, and the electronic device 106-3 is associated with the entity 110-3. The monitoring system 104 and the electronic devices 106 are communicatively coupled to each other via a communication network 108 (referred also interchangeably as network 108). The network 108 is a secure network including, but not limited to, a Local Area Network (LAN), a Wireless Local Area Network (WLAN), a Wireless Personal Area Network (WPAN), a Small Area Network (SAN), a telecommunication network including, but not limited to, a fourth generation (4G) and a fifth generation (5G) cellular network, and other wireless communication networks employing infra-red beams/signals, radio frequency (RF) signals, or other forms of wireless communication, and utilizing any of a variety of communications protocols, as is now known or in the future developed.

In accordance with various embodiments, the monitoring system 104 is configured to detect the movement of the entity 110 within the zone 102 and transmit a first encrypted wireless signal in the zone 102 in response to the detected movement. The monitoring system 104 is further configured to authenticate the electronic device 106 (associated with the entity 110) based on a second encrypted wireless signal received from the electronic device 106 and authorize the detected movement of the corresponding entity 110 upon the authentication of the electronic device 106. The monitoring system 104 is further configured to deactivate an alarm 118 or a response device 116 based on the authorization. In some embodiments, for example, upon non-receipt of the second encrypted wireless signal within a predefined time duration or a failure of the authentication of the at least one electronic device, the monitoring system 104 is configured to activate the alarm 118 and/or the response device 116 (described in detail below).

In accordance with various embodiments, the first encrypted wireless signal corresponds to any encrypted challenge signal transmitted from the monitoring system 104 for authentication of the electronic device 106. For example, the first encrypted wireless signal includes a challenge for the electronic device 106. In some embodiments, the first encrypted wireless signal includes a dynamic key valid for the predefined time duration for authentication of the electronic device 106. The second encrypted wireless signal corresponds to any encrypted challenge response signal transmitted by the electronic device 106 for the authentication of the electronic device 106 to the monitoring system 104. For example, the second encrypted wireless signal includes a challenge response to the challenge provided in the first encrypted wireless signal. In some embodiments, the second encrypted wireless signal includes at least one of a first identification of the second encrypted wireless signal, a code, a certificate of the electronic device 106, a radio-frequency fingerprint of the second encrypted wireless signal, the challenge response, or any other identification now known or in the future developed. For example, each communication session between the monitoring system 104 and the electronic device 106 is applicable for a predefined time period and each communication session implements a one-time-use code or a ‘rolling code’ to enable the monitoring system 104 to verify, validate, and/or authenticate the electronic device 106 for the corresponding communication session. Further, the one-time-use code is updated or modified for each subsequent communication session after the predefined time period of a current communication session. In another example, the second encrypted wireless signal includes one or more device authentication certificates to be validated by the monitoring system 104. As another example, the second encrypted signal includes the radio-frequency fingerprint corresponding to a predefined radio waveform transmitted by and uniquely identifying the electronic device 104, thereby enabling the monitoring system 104 to verify/validate the electronic device 106.

The various components of the monitoring system 104 will now be described hereinafter with respect to FIG. 1. It should be appreciated by those of ordinary skill in the art that FIG. 1 depicts the monitoring system 104 in a simplified manner and a practical embodiment includes additional components and suitably configured logic to support known or conventional operating features that are not described in detail herein. Although the monitoring system 104 is illustrated and described to be implemented within a single device, it is contemplated that the one or more components of the monitoring system 104 are alternatively implemented in a distributed computing environment, without deviating from the scope of the claimed subject matter. It will further be appreciated by those of ordinary skill in the art that one or more components of the monitoring system 104 alternatively functions within a remote server, cloud computing device, or any other remote computing mechanism now known or developed in the future.

The monitoring system 104 includes at least one detector 112, at least one beacon 114, the response device 116, the alarm 118, and a server 120. The components of the monitoring system 104, including the detector 112, the beacon 114, the response device 116, the alarm 118, and the server 120 are communicatively coupled one another to enable operations of the monitoring system 104. In accordance with various embodiments when the components of the monitoring system 104 are implemented within a single device, each component communicates with one another via a monitoring system local interface (not illustrated). The monitoring system local interface includes, but not limited to, one or more buses or other wired or wireless connections, as is known in the art. The monitoring system local interface includes additional elements, which are omitted for simplicity, such as controllers, buffers (caches), drivers, repeaters, and receivers, among many others, to enable communications. Further, the monitoring system local interface includes address, control, and/or data connections to enable appropriate communications among the aforementioned components.

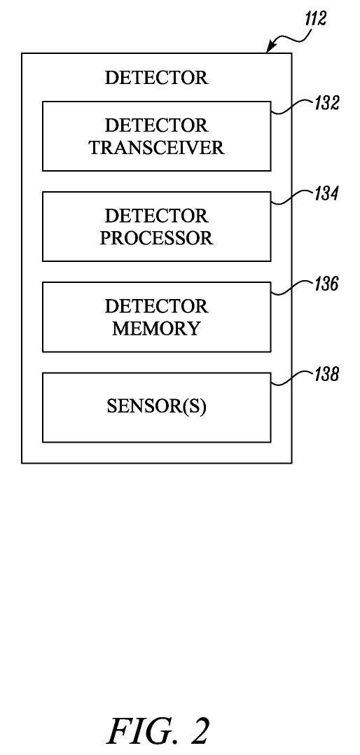

In accordance with various embodiments, the detector 112 is configured to detect the movement of the entity 110 within the zone 102 and sends a signal to the beacon 114 to transmit the first encrypted wireless signal in the zone 102 in response to the detected movement. In accordance with various embodiments, detecting the movement of the entity 110 also includes detecting a presence of the entity 110 in the zone 102 without deviating from the scope of the present description. The detector 112 corresponds to any motion detection device configured to detect the movement of the entity 110 within the zone 102. For example, the detector 112 corresponds to any motion sensing device now known or in the future developed to detect the movement of the entity 110 within the zone 102. The various components of the detector 112 will now be described hereinafter with respect to FIG. 2. It should be appreciated by those of ordinary skill in the art that FIG. 2 depicts the detector 112 in a simplified manner and a practical embodiment includes additional components and suitably configured logic to support known or conventional operating features that are not described in detail herein. Although the detector 112 is illustrated and described to be implemented within a single communication device, it is contemplated that the one or more components of the detector 112 are alternatively implemented in a distributed computing environment.

Referring to FIG. 2, the detector 112 includes, among other components, a detector transceiver 132, a detector processor 134, a detector memory 136, and one or more sensors 138. The components of the detector 112, including the detector transceiver 132, the detector processor 134, the detector memory 136, and the sensor 138, cooperate with one another to enable operations of the detector 112. Each component communicates with one another via a detector local interface (not illustrated). The detector local interface includes, but not limited to, one or more buses or other wired or wireless connections, as is known in the art. The detector local interface includes additional elements, which are omitted for simplicity, such as controllers, buffers (caches), drivers, repeaters, and receivers, among many others, to enable communications. Further, the detector local interface includes address, control, and/or data connections to enable appropriate communications among the aforementioned components.

As illustrated, the detector 112 includes the detector transceiver 132 to transmit data and/or signals to and receive data and/or signals from one or more other components of the monitoring system 104, such as, (as illustrated in FIG. 1) the beacon 114 and the server 120. For example, the detector transceiver 132 is configured to transmit the signal to the beacon 114 to transmit the first encrypted wireless signal in response to the detected movement of the entity within the zone 102. Similarly, in some embodiments, the detector transceiver 132 is configured to transmit at least one input associated with the detected movement to the server 120. For example, the at least one input includes data (for example, but not limited to, temperature data, visual image data, or thermal image data or any other detection data now known or in the future developed) associated with the zone 102 for detecting the movement of the entity 110 within the zone 102. The detector transceiver 132 includes a transmitter circuitry and a receiver circuitry to enable the detector 112 to communicate with the one or more other components. In this regard, the transmitter circuitry includes appropriate circuitry to transmit the one or more signals to the one or more other components and the receiver circuitry includes appropriate circuitry to receive the one or more signals from the one or more other components. It will be appreciated by those of ordinary skill in the art that the detector 112 includes a single detector transceiver 132 as illustrated, or alternatively separate transmitting and receiving components, for example but not limited to, a transmitter, a transmitting antenna, a receiver, and a receiving antenna. In some embodiments, when the components of the monitoring system 104 are implemented within a single device, the detector 112 communicates with the one or more other components using any on-board communication, for example, the monitoring system local interface.

The detector memory 136 is a non-transitory memory configured to store a set of instructions that are executable by the detector processor 134 to perform predetermined operations. For example, the detector memory 136 includes any of the volatile memory elements (for example, random access memory (RAM)), non-volatile memory elements (for example, read only memory (ROM)), and combinations thereof. Moreover, the detector memory 136 incorporates electronic, magnetic, optical, and/or other types of storage media. In accordance with various embodiments, the detector memory 136, for example, is configured to store a predetermined temperature threshold value and a predetermined thermal threshold value for detecting the movement of the entity 110 within the zone 102.

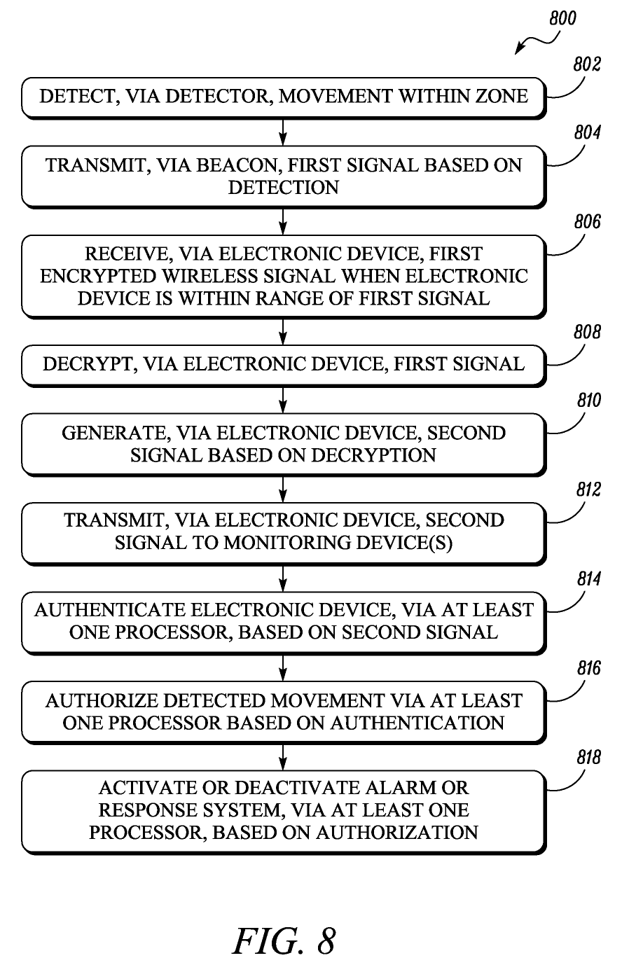

The detector processor 134 is configured to execute the instructions stored in the detector memory 136 to perform the predetermined operations. The detector processor 134 includes one or more microprocessors, microcontrollers, DSPs (digital signal processors), state machines, logic circuitry, or any other device or devices that process information or signals based on operational or programming instructions. The detector processor 134 is implemented using one or more controller technologies, such as Application Specific Integrated Circuit (ASIC), Reduced Instruction Set Computing (RISC) technology, Complex Instruction Set Computing (CISC) technology, or any other similar technology now known or in the future developed. The detector processor 134 is configured to cooperate with other components of the detector 112 to perform its operations (described in detail with reference to FIG. 8).

The sensor 138 is configured to detect the movement of the entity 110 within the zone 102. To this end, the sensor 138 is configured to capture data associated with changes in the zone 102 that indicates the movement of the entity 110 within the zone 102. In an embodiment, the sensor 138 corresponds to an infra-red sensor configured to measure infrared radiations within the zone 102 to detect changes in temperature of the zone 102. As known in the art, when an entity (for example, the entity 110) is present within the zone 102, the infra-red radiations (for example, the heat) from the entity 110 present within the zone 102 change the temperature of the zone 102. The infra-red sensor is configured to measure these changes in the infrared radiations in the zone 102 to determine the movement of the entity 110 within the zone 102 and determine the movement of the entity 110 in the zone 102 when the change in the temperature (interchangeably referred to as the temperature data) of the zone 102 is greater than the predefined temperature threshold value during a predefined time interval. In accordance with various embodiments, the predefined time interval is a time interval predefined by a user or a programmer of the monitoring system 104. It would be appreciated by a person skilled in the art that although the sensor 138 is described as the infra-red sensor, the sensor 138 in some embodiments, includes an ultrasonic sensor, a microwave sensor, a radar sensor, a proximity sensor, or any other motion detection sensor known in the art or developed in the future.

In some embodiments, the sensor 138 also includes an infra-red camera configured to measure infrared radiations within the zone 102 and convert the measured infrared radiations into a thermal image. The infra-red camera is further configured to determine a changes in the heat pattern between two or more thermal images captured between the predefined time interval, for example, using one or more motion detection algorithms and detect the movement of the entity 110 in the zone 102 when the changes in the heat pattern between the two or more thermal images (interchangeably referred to as the thermal image data) is greater than the predefined thermal threshold value. In some embodiments, the detector processor 134 is configured to obtain the two or more thermal images from the infra-red camera and determine the movement of the entity 110 in the zone 102 when the changes in the heat pattern between the two or more thermal images is greater than the predefined thermal threshold value. It would be appreciated by a person skilled in the art that although the sensor 138 is described as the infra-red camera, the sensor 138 includes any motion detection camera known in the art or developed in the future.

For example, in an embodiment, the sensor 138 corresponds to a camera configured to capture one or more visual images of the zone 102. The camera corresponds to any image capturing device, such as monochrome digital cameras, high-resolution digital cameras, or any suitable digital cameras. For example, the camera includes still camera, camcorder, video camera, Closed-Circuit Television (CCTV) camera, or any device known in the art or in the future developed to capture images of the zone 102. In accordance with various embodiments, the sensor 138 is configured to transmit data associated with the visual images (interchangeably referred to as the visual image data) to the server processor 156 or the detector processor 134 for detecting the movement of the entity 110 within the zone 102, as described in detail below.

In some alternate embodiments, the detector processor 134 is configured to obtain data, for example, the temperature and/or the thermal images from the sensor 138 and determine the movement of the entity 110 in the zone 102 based on the obtained data using the same process as described above. In some alternate embodiments, the detector transceiver 132 is configured to transmit the temperature data and/or the thermal images (hereinafter interchangeably referred to as at least one input) captured by the sensor 138 to the server 120 for detecting the movement of the entity 110 in the zone 102 based on the at least one input (using the same process as described above).

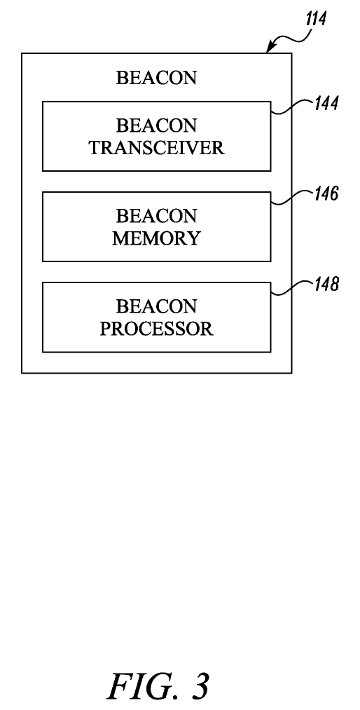

Referring back to FIG. 1, the beacon 114 is configured to transmit the first encrypted wireless signal in response to the detected movement of the entity 110 within the zone 102 and receive the second encrypted signal from the electronic device 106 associated with the entity 110 present within the zone 102. The beacon 114 corresponds to any low energy device now known or in the future developed to broadcast signals to and/or receive signals from nearby devices (for example, the electronic devices 106) in a pre-defined area (for example, the zone 102). For example, the beacon 114 corresponds to an infra-red beacon configured to broadcast and receive infra-red signals. It would be appreciated by a person skilled in the art that although the beacon 114 is described as the infra-red beacon, the beacon 114 can include other types of beacons such as, radio beacon, wireless Fidelity (WiFi) beacon, satellite radio beacons or any other types of beacons now known or developed in future. The various components of the beacon 114 will now be described hereinafter with respect to FIG. 3. It should be appreciated by those of ordinary skill in the art that FIG. 3 depicts the beacon 114 in a simplified manner and a practical embodiment includes additional components and suitably configured logic to support known or conventional operating features that are not described in detail herein. Although the beacon 114 is illustrated and described to be implemented within a single communication device, it is contemplated that the one or more components of the beacon 114 are alternatively implemented in a distributed computing environment.

Referring to FIG. 3, the beacon 114 includes, among other components, a beacon transceiver 144, a beacon processor 148, and a beacon memory 146. The components of the beacon 114, including the beacon transceiver 144, the beacon processor 148, and the beacon memory 146, cooperate with one another to enable operations of the beacon 114. Each component communicates with one another via a beacon local interface (not illustrated). The beacon local interface includes, but not limited to, one or more buses or other wired or wireless connections, as is known in the art. The beacon local interface includes additional elements, which are omitted for simplicity, such as controllers, buffers (caches), drivers, repeaters, and receivers, among many others, to enable communications. Further, the beacon local interface includes address, control, and/or data connections to enable appropriate communications among the aforementioned components.

As illustrated, the beacon 114 includes the beacon transceiver 144 to transmit one or more signals to and receive one or more signals from one or more devices and/or one or more other components of the monitoring system 104. In accordance with various embodiments, the beacon transceiver 144 is configured to transmit and/or receive low energy signals from the electronic devices 106 within the zone 102. For example, the beacon transceiver 144 is configured to broadcast the first encrypted signal to the electronic devices 106 within the zone 102 and receive the second encrypted signal from the electronic devices 106 within the zone 102. In an exemplary embodiment, when the beacon 114 corresponds to the infra-red beacon, the first encrypted signal and/or the second encrypted signal correspond to infra-red signals. In some embodiments, the beacon transceiver 144 is configured to receive the signal from the detector 112 and/or the server 120 to transmit the first encrypted wireless signal in response to the detected movement of the entity within the zone 102. The beacon transceiver 144 includes a transmitter circuitry and a receiver circuitry to enable the beacon 114 to communicate with the electronic devices 106 and/or the other components of the monitoring system 104. In this regard, the transmitter circuitry includes appropriate circuitry to transmit the one or more signals to and the receiver circuitry includes appropriate circuitry to receive the one or more signals from the electronic devices 106 and/or the other components of the monitoring system 104. It will be appreciated by those of ordinary skill in the art that the beacon 114 includes a single beacon transceiver 144 as illustrated, or alternatively separate transmitting and receiving components, for example but not limited to, a transmitter, a transmitting antenna, a receiver, and a receiving antenna. In some embodiments, when the components of the monitoring system 104 are implemented within a single device, the beacon 114 communicates with the one or more other components using any on-board communication, for example, the monitoring system local interface.

The beacon memory 146 is a non-transitory memory configured to store a set of instructions that are executable by the beacon processor 148 to perform predetermined operations. For example, the beacon memory 146 includes any of the volatile memory elements (for example, random access memory (RAM)), non-volatile memory elements (for example, read only memory (ROM)), and combinations thereof. Moreover, the beacon memory 146 incorporates electronic, magnetic, optical, and/or other types of storage media. In some embodiments, the beacon memory 146 is configured to store at least one key associated with the encryption and/or decryption of the first encrypted wireless signal and the second encrypted wireless signal. In some embodiments, the beacon memory 146 is configured to store at least one of a second identification of the second encrypted wireless signal, the code, the certificates of the electronic devices 106, the radio-frequency fingerprint of the second encrypted wireless signal, or the challenge response.

The beacon processor 148 is configured to execute the instructions stored in the beacon memory 146 to perform the predetermined operations. The beacon processor 148 includes one or more microprocessors, microcontrollers, DSPs (digital signal processors), state machines, logic circuitry, or any other device or devices that process information or signals based on operational or programming instructions. The beacon processor 148 is implemented using one or more controller technologies, such as Application Specific Integrated Circuit (ASIC), Reduced Instruction Set Computing (RISC) technology, Complex Instruction Set Computing (CISC) technology, or any other similar technology now known or in the future developed. The beacon processor 148 is configured to cooperate with other components of the beacon 114 to perform its operations.

In accordance with various embodiments, the beacon processor 148 is configured to control the beacon transceiver 144 to transmit or broadcast the first encrypted wireless signal and receive the second encrypted wireless signal from the electronic devices 106. In some embodiments, the beacon processor 148 is configured to generate the first encrypted wireless signal and authenticate the electronic device 106 based on the received second encrypted wireless signal (as described in detail below with reference to FIG. 8).

Referring back to FIG. 1, the server 120 is configured to authenticate the electronic device(s) 106 based on the received second encrypted wireless signal and authorize the detected movement of the entity 110 upon the authentication of the corresponding electronic device 106. In some embodiments, the server 120 is configured to control and/or instruct the one or more other components of the monitoring system 104 to perform their operations. For example, the server 120 is configured to control and/or instruct the detector 112 to detect the movement of the entity 110 within the zone 102. Similarly, the server 120 is configured to control the beacon 114 to transmit the first encrypted wireless signal in response to the detected movement of the entity 110 within the zone 102 and receive the second encrypted signal from the electronic device 106 associated with the entity 110 present within the zone 102. Further, the server 120 is configured to activate or deactivate the alarm 118 and/or the response device 116 based on the authorization.

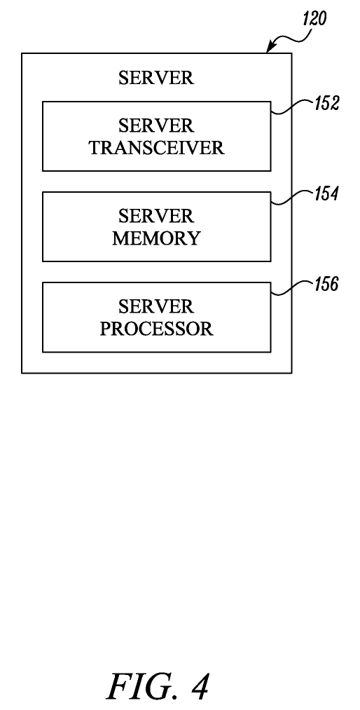

The various components of the server 120 will now be described hereinafter with respect to FIG. 4. It should be appreciated by those of ordinary skill in the art that FIG. 4 depicts the server 120 in a simplified manner and a practical embodiment includes additional components and suitably configured logic to support known or conventional operating features that are not described in detail herein. Although the server 120 is illustrated and described to be implemented within a single communication device, it is contemplated that the one or more components of the server 120 are alternatively implemented in a distributed computing environment. It will further be appreciated by those of ordinary skill in the art that one or more components of the server 120 alternatively functions within a remote server, cloud computing device, or any other remote computing mechanism now known or developed in the future.

Referring to FIG. 4, the server 120 includes, among other components, a server transceiver 152, a server processor 156, and a server memory 154. The components of the server 120, including the server transceiver 152, the server processor 156, and the server memory 154, cooperate with one another to enable operations of the server 120. Each component communicates with one another via a server local interface (not illustrated). The server local interface includes, but not limited to, one or more buses or other wired or wireless connections, as is known in the art. The server local interface includes additional elements, which are omitted for simplicity, such as controllers, buffers (caches), drivers, repeaters, and receivers, among many others, to enable communications. Further, the server local interface includes address, control, and/or data connections to enable appropriate communications among the aforementioned components.

As illustrated, the server 120 includes the server transceiver 152 to transmit one or more signals to and receive one or more signals from one or more devices and/or other components of the monitoring system 104. For example, the server transceiver 152 is configured to receive the second encrypted wireless signal, via the beacon 114, from the electronic device 106 and transmit a signal to the alarm 118 and/or the response device 116 to deactivate or activate the alarm 118 and/or the response device 116 based on the authorization. In some embodiments, the server transceiver 152 is configured to receive the at least one input associated with the detected movement from the detector 112 and initiate the transmission of the first encrypted wireless signal via the beacon 114 based on the at least one received input. The server transceiver 152 includes a transmitter circuitry and a receiver circuitry to enable the server 120 to communicate with the one or more devices and/or other components of the monitoring system 104. In this regard, the transmitter circuitry includes appropriate circuitry to transmit the one or more signals to and the receiver circuitry includes appropriate circuitry to receive the one or more signals from the one or more devices and/or other components of the monitoring system 104. It will be appreciated by those of ordinary skill in the art that the server 120 includes a single server transceiver 152 as illustrated, or alternatively separate transmitting and receiving components, for example but not limited to, a transmitter, a transmitting antenna, a receiver, and a receiving antenna. In some embodiments, when the components of the monitoring system 104 are implemented within a single device, the server 120 communicates with the one or more other components using any on-board communication, for example, the monitoring system local interface.

The server memory 154 is a non-transitory memory configured to store a set of instructions that are executable by the server processor 156 to perform predetermined operations. For example, the server memory 154 includes any of the volatile memory elements (for example, random access memory (RAM)), non-volatile memory elements (for example, read only memory (ROM)), and combinations thereof. Moreover, the server memory 154 incorporates electronic, magnetic, optical, and/or other types of storage media. In accordance with various embodiments, the server memory 154 is configured to store the predetermined temperature threshold value and the predetermined thermal threshold value for detecting the movement of the entity 110 within the zone 102. In some embodiments, the server memory 154 is configured to store at least one of a second identification of the second encrypted wireless signal, the code, the certificates of the electronic devices 106, the radio-frequency fingerprint of the second encrypted wireless signal, or the challenge response. In some embodiments, the server memory 154 is configured to store the at least one key associated with the encryption and/or decryption of the first encrypted wireless signal and the second encrypted wireless signal.

The server processor 156 is configured to execute the instructions stored in the server memory 154 to perform the predetermined operations. In accordance with various embodiments, the server processor 156 is configured to generate the first encrypted wireless signal and broadcast, via the beacon 114, the first encrypted wireless signal in the zone 102. The server processor 156 is further configured to authenticate the electronic device 106 based on the received second encrypted wireless signal and authorize the detected movement of the entity 110 upon the authentication of the corresponding electronic device 106. The server processor 156 is further configured to deactivate the alarm 118 or the response device 116 based on the authorization and/or activate the alarm 118 or the response device 116 upon non-receipt of the second encrypted wireless signal within the predefined time duration or a failure of the authentication of the electronic device 106. In accordance with various embodiments, the server processor 156 is configured to authorize the detected movement or deactivate the alarm 118 or the response device 116 for a predetermined time duration. The predetermined time duration is any time duration predetermined by the programmer or the user of the monitoring system 104.

In some embodiments, the server processor 156 (hereinafter interchangeably referred to as a processor or at least one processor of the monitoring system 104) corresponds to the detector processor 134 (hereinafter interchangeably referred to as a first processor) associated with the detector 112 to detect the movement and/or the beacon processor 148 (hereinafter interchangeably referred to as a second processor) associated with the beacon 114 to transmit the first encrypted signal based on the detected movement. In such cases, the server processor 156 is configured to receive, via the server transceiver 152, the at least one input (for example, the temperature data and/or the thermal images) associated with the detected movement from the detector transceiver 132 of the detector 112 and detect the movement of the entity 110 within the zone 102 based on the at least one input. The server processor 156 is further configured to initiate the transmission of the first encrypted wireless signal via the beacon transceiver 144 of the beacon 114 based on the at least one received input, for example, in response to the detected movement.

The server processor 156 includes one or more microprocessors, microcontrollers, DSPs (digital signal processors), state machines, logic circuitry, or any other device or devices that process information or signals based on operational or programming instructions. The server processor 156 is implemented using one or more controller technologies, such as Application Specific Integrated Circuit (ASIC), Reduced Instruction Set Computing (RISC) technology, Complex Instruction Set Computing (CISC) technology, or any other similar technology now known or in the future developed. The server processor 156 is configured to cooperate with other components of the server 120 to perform its operations (described in detail with reference to FIG. 8).

Referring back to FIG. 1, the response device 116 and/or the alarm 118 is configured to be activated or deactivated by the server 120 based on one or more signals/instructions received from the server 120. For example, the response device 116 and/or the alarm 118 is configured to be activated when a non-authorized entry of the entity 110 is detected within the zone 102. Similarly, the response device 116 and/or the alarm 118 is configured to be deactivated when an authorized entry of the entity 110 is detected within the zone 102. In accordance with various embodiments, when the server 120 authenticates the electronic device 106 and authorizes the movement of the entity 110 associated with the electronic device 106, the server 120 deactivates the response device 116 and/or the alarm 118. Similarly, the server 120 activates the alarm 118 and/or the response device 116 upon non-receipt of the second encrypted wireless signal within the predefined time duration or a failure of the authentication of the electronic device 106.

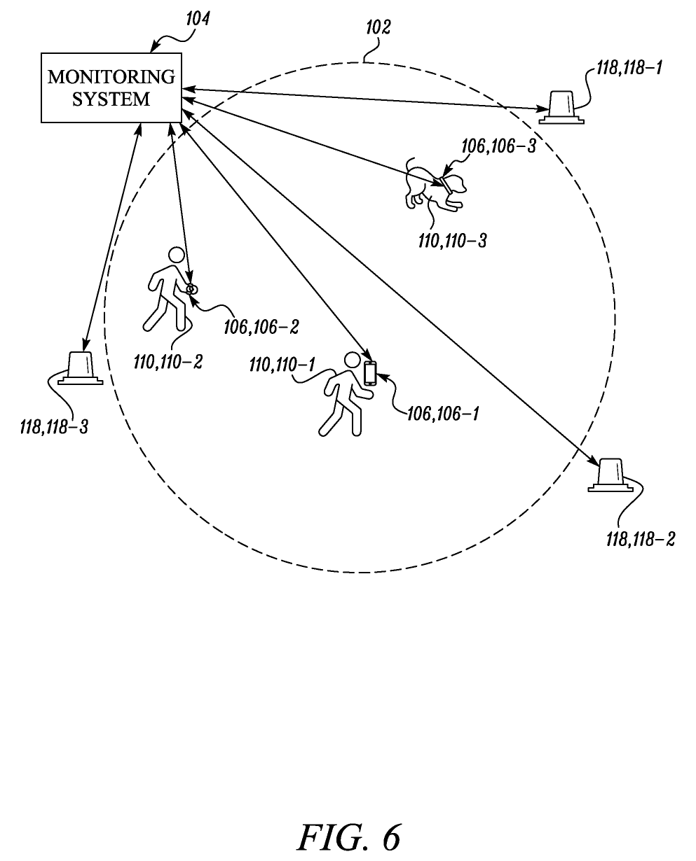

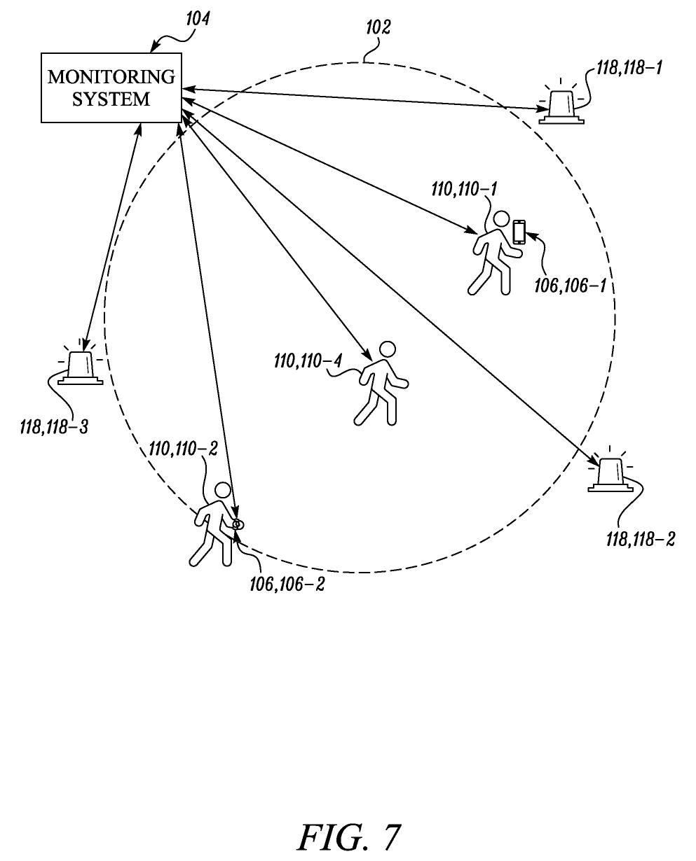

The response device 116 corresponds to any device capable of providing alerts associated with a non-authorized entry of the entity 110 within the zone 102. For example, the response device 116 includes one or more of a display capable of providing visual alerts, a communication device capable of sending messages, an audio device capable of providing audio alerts or any other device known in the art of developed in the future to provide one or more types of alerts to one or more users of the monitoring system 104. In some embodiments, when the monitoring system 104 identifies and/or authorizes the entity 110 associated with the movement, the response device 116 is configured to include the identification of the entity 110 in the alerts. In some embodiments, the response device 116 is a computing device capable of controlling one or more structures, for example, gates, fences, windows, jammers, systems to attack intruders, and similar systems or structures associated with the monitoring system 104 based on one or more signals/instructions received from the server 120. For example, the response device 116 is configured to close the gates and/or windows of one or more buildings in the zone 102 when a non-authorized entry of the entity 110 is detected within the zone 102. The alarm 118 corresponds to any audio device capable of providing audio alerts to the one or more users of the monitoring system 104 based on the signal/instructions from the server 120. For example, the alarm 118 is configured to provide the audio alerts to the user of the monitoring system 104 when a non-authorized entry of the entity 110 is detected within the zone 102. In some embodiments (not illustrated), the response device 116 includes the alarm 118. In some embodiments, depending upon the requirement of the user of the monitoring system 104, the monitoring system 104 includes more than one alarms 118 (for example, alarms 118-1, 118-2, and 118-3 illustrated in FIGS. 6 and 7) installed at different locations within or outside the zone 102.

Referring back to FIG. 1, each electronic device 106 is associated (for example, worn or attached to) the corresponding entity 110. The electronic device 106 corresponds to at least one of a wearable device, a portable device, or any other communication device now known or in the future developed. For example, as illustrated in FIG. 1, the electronic device 106 is a smartphone 106-1, a smartwatch 106-2, an electronic tag 106-3 or any other communication device capable of communicating with the monitoring system 104, now known or in the future developed. Each electronic device 106 is configured to receive the first encrypted wireless signal broadcasted by the monitoring system 104 when the electronic device 106 is within a range of the first encrypted wireless signal. The electronic device 106 is further configured to decrypt the first encrypted wireless signal, generate the second encrypted wireless signal based on the decryption, and transmit the second encrypted wireless signal to the monitoring system 104. In accordance with various embodiments, the range of the first encrypted wireless signal from the monitoring system 104 is configured to ensure coverage of the entire zone 102. In some embodiments, the range of the first encrypted wireless signal is geographically constrained to the zone 102.

In an exemplary embodiment, the electronic device 106 is configured to operate in two different power modes, for example, a low power mode and a full power mode, with a power consumption in the low power mode being substantially lower when compared to a power consumption in the full power mode. For example, the electronic device 106 is configured to power the electronic device transceiver 162 and one or more sub-controllers of the electronic device processor 166 in the low power mode, and each of the electronic device transceiver 162, the electronic device memory 164, and all controllers and/or sub-controllers of the electronic device processor 166 in the full power mode. The one or more sub-controllers of the electronic device processor 166 are configured to control the powering of the other controllers of the electronic device processor 166 when the electronic device 106 is switched from the low power mode to the full power mode.

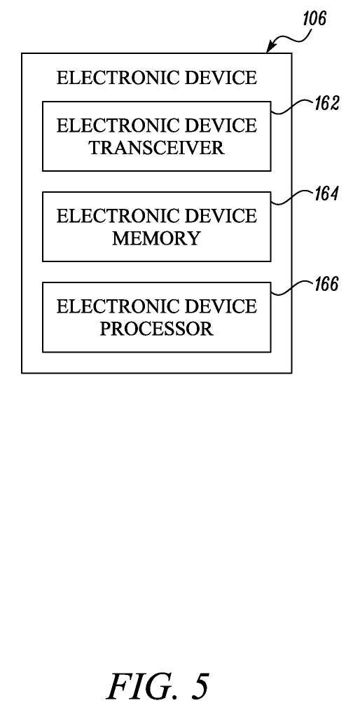

The various components of electronic device 106 will now be described hereinafter with respect to FIG. 5. It should be appreciated by those of ordinary skill in the art that FIG. 5 depicts the electronic device 106 in a simplified manner and a practical embodiment includes additional components and suitably configured logic to support known or conventional operating features that are not described in detail herein. Although the electronic device 106 is illustrated and described to be implemented within a single communication device, it is contemplated that the one or more components of the electronic device 106 are alternatively be implemented in a distributed computing environment

Referring to FIG. 5, the electronic device 106 includes, among other components, an electronic device transceiver 162, an electronic device memory 164, and an electronic device processor 166. The components of the electronic device 106, including the electronic device transceiver 162, the electronic device memory 164, and the electronic device processor 166, cooperate with one another to enable operations of the electronic device 106. Each component communicates with one another via a device local interface (not illustrated). The device local interface includes, but not limited to, one or more buses or other wired or wireless connections, as is known in the art. The device local interface includes additional elements, which are omitted for simplicity, such as controllers, buffers (caches), drivers, repeaters, and receivers, among many others, to enable communications. Further, the device local interface includes address, control, and/or data connections to enable appropriate communications among the aforementioned components.

As illustrated, the electronic device 106 includes the electronic device transceiver 162 to transmit one or more signals to and receive one or more signals from the monitoring system 104 (as illustrated in FIG. 1). For example, the device transceiver 162 is configured to receive the first encrypted wireless signal from the monitoring system 104 and transmit the second encrypted wireless signal to the monitoring system 104. The device transceiver 162 includes a transmitter circuitry and a receiver circuitry to enable the electronic device 106 to communicate with the monitoring system 104. In this regard, the transmitter circuitry includes appropriate circuitry to transmit the second encrypted wireless signal to and the receiver circuitry includes appropriate circuitry to receive the first encrypted wireless signal from the monitoring system 104. It will be appreciated by those of ordinary skill in the art that the electronic device 106 includes a single device transceiver 162 as illustrated, or alternatively separate transmitting and receiving components, for example but not limited to, a transmitter, a transmitting antenna, a receiver, and a receiving antenna. In accordance with various embodiments, the electronic device transceiver 162 also includes an infra-red transceiver module (not illustrated) to transmit and receive one or more infra-red signals (for example, the first encrypted wireless signal and the second encrypted wireless signal) to and/or from the monitoring system 104. It would be appreciated that the components and functionality of the infra-red transceiver module integrated in the device transceiver 162 of the electronic device 106 is well known in the art and is not described here for the sake of brevity. In some embodiments (not illustrated), the infra-red transceiver module is a separate from the device transceiver 162.

The electronic device memory 164 is a non-transitory memory configured to store a set of instructions that are executable by the electronic device processor 166 to perform predetermined operations. For example, the electronic device memory 164 includes any of the volatile memory elements (for example, random access memory (RAM)), non-volatile memory elements (for example, read only memory (ROM)), and combinations thereof. Moreover, the electronic device memory 164 incorporates electronic, magnetic, optical, and/or other types of storage media. In accordance with some embodiments, the electronic device memory 164 is also configured to store the at least one key associated with the encryption and/or decryption of the first encrypted wireless signal and the second encrypted wireless signal. In some embodiments, the electronic device memory 164 is also configured to store a cryptographic key to generate the challenge response.

The electronic device processor 166 is configured to execute the instructions stored in the electronic device memory 164 to perform the predetermined operations. In accordance with various embodiments, the electronic device processor 166 is configured to decrypt the first encrypted wireless signal and generate the second encrypted wireless signal based on the decryption. The electronic device processor 166 is further configured to control the electronic device transceiver 162 to transmit the second encrypted wireless signal to the monitoring system 104. In some embodiments, the electronic device processor 166 is configured to modify the power state of the electronic device 106 from the low power mode to the full power mode based on the first encrypted wireless signal (for example, upon receipt of the first encrypted wireless signal).

The electronic device processor 166 includes one or more microprocessors, microcontrollers, DSPs (digital signal processors), state machines, logic circuitry, or any other device or devices that process information or signals based on operational or programming instructions. The electronic device processor 166 is implemented using one or more controller technologies, such as Application Specific Integrated Circuit (ASIC), Reduced Instruction Set Computing (RISC) technology, Complex Instruction Set Computing (CISC) technology, or any other similar technology now known or in the future developed. The electronic device processor 166 is configured to cooperate with other components of the electronic device 106 to perform its operations (described in detail with reference to FIG. 8).

In some embodiments, the system 100 is configured for self-authentication of the at least one electronic device 106 associated with the at least one entity 110 during movement in the zone 102. To this end, each electronic device 106 is configured to detect, via the electronic device processor 166 and the electronic device transceiver 162, the monitoring system 104 within a proximity of the electronic device 106 during the movement. In such cases, the monitoring system 104 is configured to broadcast, via the beacon 114, a beacon signal at regular intervals in the zone 102 and the electronic device 106 is configured to perform a network scan to detect the beacon signal transmitted by the monitoring system 104. The electronic device 106 is configured to detect the monitoring system 104 within the proximity of the electronic device 106 upon detection of the beacon signal.

The electronic device 106 is further configured to transmit, via the electronic device processor 166 and the electronic device transceiver 162, an encrypted wireless signal based on the detection. The encrypted wireless signal corresponds to any self-authentication signal transmitted by the electronic device 106 to the monitoring system 104. For example, the encrypted wireless signal includes self-authentication data associated with the electronic device 106 and encrypted using the at least one key. In accordance with various embodiments, the self-authentication data includes one or more of an identification of the electronic device 106, the certificate of the electronic device 106, the radio-frequency fingerprint of the encrypted wireless signal, or any other data for the self-authentication of the electronic device 106.

The monitoring system 104 is configured to receive, via the beacon 114, the encrypted wireless signal and decrypts, via the at least one processor (for example, the server processor 156 or the beacon processor 148) the encrypted wireless signal. For example, the at least one processor is configured to decrypt the encrypted wireless signal using the at least one key stored in the server memory 154 or the beacon memory 146. The monitoring system 104 is further configured to obtain the self-authentication data based on the decryption and authenticate, via the at least one processor, the electronic device 106 based on the self-authentication data. To this end, the at least one processor is configured to authenticate the electronic device 106 based on the self-authentication data using one or more techniques known in the art or developed in the future. For example, the at least one processor is configured to match the self-authentication data with a predefined authentication data stored in the server memory 154 or the beacon memory 146. The monitoring system 104 is further configured to authorize the movement of the at least one entity based on the authentication and activate or deactivate the alarm 118 or the response device 116 based on the authorization.

Referring to FIG. 8, an exemplary method 800 for authorizing the movement of the entity 110 within the zone 102 is illustrated and described. It would be appreciated by the person skilled in the art that although the method 800 is described for authorizing the movement of one entity 110 within the at least one zone 102, the same method 800 is applicable for authorizing the movement of each entity of the plurality of entities 110-1, 110-2, 110-3 within the zone 102. The method 800 begins, at 802, with the monitoring system 104 detecting, via the detector 112 and at least one processor of the monitoring system 104, the movement of the entity 110 within the zone 102. To this end, the monitoring system 104 periodically, for example, after every specified time period, scans the zone 102 to detect the movement of the entity 110 within the zone 102.

In accordance with various embodiments, the at least one processor of the monitoring system 104 corresponds to the detector processor 134 and/or the server processor 156 of the monitoring system 104. To this end, the sensor 138 captures the data (for example, the temperature data, the visual image data, the thermal image data, or any other detection data) associated with the changes in the zone 102 and provides the data to the server processor 156 or the detector processor 134. As discussed above, the sensor 138 corresponds to the infra-red sensor that measures the infrared radiations emitted by the entity 110 within the zone 102 to detect the changes in the temperature of the zone 102 due to the movement of the entity 110 within the zone 102. The server processor 156 or the detector processor 134 determines the movement of the entity 110 in the zone 102 when the change in the temperature of the zone 102 is greater than the predefined temperature threshold value during the predefined time interval. In some embodiments, the sensor 138 includes the infra-red camera that measures the infrared radiations within the zone 102 and converts the measured infrared radiations into a thermal image. The server processor 156 or the detector processor 134 determines the movement of the entity 110 in the zone 102 when the changes in the heat pattern between the two or more thermal images is greater than the predefined thermal threshold value. In some embodiments, when the sensor 138 includes the camera that captures the visual images of the zone 102. The server processor 156 or the detector processor 134 is configured to detect the movement in the zone 102 based on at least one image input (for example, the visual images) received via the camera. For example, the server processor 156 or the detector processor 134 is configured to detect the movement and identify the entity 110 associated with the movement using one or more artificial intelligence or machine learning models based on the received image input. It would be appreciated by a person skilled in the art that the detection of movement and the identification of an entity 110 in one or more visual images using artificial intelligence or machine learning models is known in the art and hence the details of the same are not described here for the sake of brevity. In some other embodiments, the server processor 156 or the detector processor 134 is configured to detect the movement and identify the entity 110 associated with the movement based on a stored memory of the entities 110.

At 804, the monitoring system 104 transmits, via the beacon 114 and the at least one processor of the monitoring system 104, the first encrypted wireless signal based on the detection. In accordance with various embodiments, the at least one processor of the monitoring system 104 corresponds to the beacon processor 148 or the server processor 156 of the monitoring system 104. The at least one processor of the monitoring system 104 is configured to receive the signal associated with the detection of the movement of the entity 110 within the zone 102 from the detector 112 and transmit, via the beacon transceiver 144, the first encrypted wireless signal in the zone 102 in response to the detected movement.

In an embodiment, the at least one processor of the monitoring system 104 generates a wireless signal including at least the challenge and encrypts the wireless signal using the at least one key stored in the beacon memory 146 and/or the server memory 154, to generate the first encrypted wireless signal. For example, the challenge corresponds to a randomly generated string or value created using various mechanisms known in the art or in the future developed. The at least one processor further transmits, via the beacon transceiver 144, the first encrypted wireless signal in the zone 102 in response to the detected movement.

In an embodiment, the at least one processor of the monitoring system 104 generates the dynamic key valid for the predefined time duration. The dynamic key corresponds to any key that is determined or generated at runtime rather than being fixed or known beforehand. The at least one processor of the monitoring system 104 generates the dynamic key using various mechanisms known in the art or in the future developed. For example, in some embodiments, the at least one processor of the monitoring system 104 generates the dynamic key periodically based on a previous key and data record. In some other embodiments, the at least one processor of the monitoring system 104 generates the dynamic key using a shared secret key.

The at least one processor of the monitoring system 104 generates the first encrypted wireless signal comprising the dynamic key and transmits, via the beacon transceiver 144, the first encrypted wireless signal in the zone 102 in response to the detected movement. It would be appreciated by the person skilled in the art that although the first encrypted wireless signal is described as including the dynamic key, the first encrypted wireless signal can include other data, such as the identifier of the monitoring system 104 and the timestamp of the validity of the dynamic key, without deviating from the scope of the present description.

At 806, the electronic device 106 associated with the entity 110 receives, via the electronic device transceiver 162, the first encrypted wireless signal when the electronic device 106 is within the range of the first encrypted wireless signal (for example, within the zone 102). In some embodiments, the one or more sub-controllers of the electronic device processor 166 modifies the power state of the electronic device 106 from the low power mode to the full power mode based on the first encrypted wireless signal (for example, upon reception of the first encrypted wireless signal).

At 808, the electronic device 106 decrypts, via the electronic device processor 166, the first encrypted wireless signal. To this end, the electronic device processor 166 obtains the at least one key stored in the electronic device memory 164 and decrypts the first encrypted wireless signal based on the at least one key to obtain the challenge.

At 810, the electronic device 106 generates, via the electronic device processor 166, the second encrypted wireless signal based on the decryption. To this end, the electronic device processor 166 generates the challenge response to the obtained challenge. For example, the challenge response is generated by combining the challenge with the cryptographic key stored in the electronic device memory 164. In accordance with various embodiments, the cryptographic key is different for each electronic device 106. The electronic device processor 166 then encrypts the challenge response with the at least one key stored in the electronic device memory 164 to generate the second encrypted wireless signal. In some embodiments, the second encrypted wireless signal includes at least one of the first identification of the second encrypted wireless signal, the code, the certificate of the electronic device 106, the radio-frequency fingerprint of the second encrypted wireless signal, or the challenge response.

At 812, the electronic device 106 transmits, via the electronic device processor 166 and the electronic device transceiver 162, the second encrypted wireless signal to the monitoring system 104. For example, the electronic device 106 transmits, via the electronic device processor 166 and the electronic device transceiver 162, the second encrypted wireless signal to the at least one processor of the monitoring system 104. As discussed above, the at least one processor of the monitoring system 104 corresponds to the beacon processor 148 or the server processor 156 of the monitoring system 104.

At 814, the at least one processor of the monitoring system 104 authenticates the electronic device 106 based on the second encrypted wireless signal. To this end, the server processor 156 obtains the at least one key stored in the beacon memory 146 and/or the server memory 154 and decrypts the second encrypted wireless signal based on the at least one key to obtain the challenge response. The server processor 156 then compares the challenge response with a predetermined challenge response stored in the beacon memory 146 and/or the server memory 154 to authenticate the electronic device 106.

In some embodiments, the second encrypted wireless signal includes at least one of the first identification of the second encrypted wireless signal, the code, the certificate of the electronic device 106, the radio-frequency fingerprint of the second encrypted wireless signal, or the challenge response, the at least one processor of the monitoring system 104 decrypts the second encrypted wireless signal and obtains the at least one first identification, the code, the certificate, the radio-frequency fingerprint, or the challenge response based on the decryption. The at least one processor further determines a match between the at least one first identification, the code, the certificate, the radio-frequency fingerprint, or the challenge response and at least one of the second identification, the code, the certificate, the radio-frequency fingerprint, or the challenge response stored in a storage unit (for example, the server memory 154 or the beacon memory 146) of the at least one monitoring system 104. The monitoring system 104 then authenticates the electronic device 106 based on the determined match.

In some embodiments, a frequency associated with the first encrypted wireless signal and the second encrypted wireless signal is the same or different. In such cases, the monitoring system 104 authenticates the electronic device 106 based on the frequency of the second encrypted wireless signal. For example, the radio wave frequency of the first encrypted signal transmitted by the monitoring system 104 is different from the radio wave frequency of the second encrypted signal transmitted by the electronic device 106 and the monitoring system 104 is configured to authenticate the electronic device 104 based on the radio wave frequency of the second encrypted signal transmitted by the electronic device 106.

In some embodiments, the monitoring system 104 is configured to authenticate the electronic device 106 based on the second encrypted wireless signal received within the predefined time duration. For example, the monitoring system 104 is configured to define the predefined time duration to receive the response via the first encrypted signal and thereafter, configured to authenticate the electronic device 104 for instances when the second encrypted signal is received within the predefined time duration.

At 816, the monitoring system 104 authorizes, via the at least one processor of the monitoring system 104 (for example, the server processor 156), the detected movement of the entity 110 associated with the electronic device 106 based on the authentication. At 818, the monitoring system 104 activates or deactivates, via the at least one processor of the monitoring system 104 (for example, the server processor 156), the alarm 118 or the response device 116 based on the authorization. In some embodiments, the monitoring system 104 authorizes the detected movement or deactivates the alarm 118 or the response device 116 for the predetermined time duration. Alternatively, the monitoring system 104 activates the alarm 118 or the response device 116 upon the non-receipt of the second encrypted wireless signal within the predefined time duration or the failure of the authentication of the electronic device 106. In accordance with various embodiments, the monitoring system 104 is configured to request the electronic device 106 to reauthenticate itself after the predefined time duration. To this end, the method 800 loops back to 802 after the predefined time duration to detect the movement or presence of the entity 110 in the zone 102. Alternatively, the electronic device 106 is configured to reauthenticate itself after the predefined time duration by providing the self-authentication data to the monitoring system 102 for self-authentication.

In some embodiments, when the monitoring system 104 detects the movement of a plurality of entities 110 in the zone 102, the monitoring system 104 authorizes the movement of the plurality of entities 110 when a number of the electronic devices 106 authenticated by the monitoring system 104 correspond to a number of the plurality of entities 110 detected in the zone 102. For example, as illustrated in FIG. 6, the monitoring system 104 deactivates the alarms 118-1, 118-2, 118-3 when three (3) electronic devices 106-1, 106-2, 106-3 authenticated by the monitoring system 104 corresponds to three (3) entities 110-1, 110-2, 110-3 detected in the zone 102. Alternatively, the monitoring system 104 detects a non-authorized movement of at least one entity 110 of the plurality of entities 110 in the zone 102, when even a single electronic device 106 is not authenticated, for example, when a number of the electronic devices 106 authenticated by the monitoring system 104 is less than a number of the plurality of entities 110 detected in the zone 102. For example, as illustrated in FIG. 7, the monitoring system 104 activates the alarms 118-1, 118-2, 118-3 when only two (2) electronic devices 106-1, 106-2 are authenticated by the monitoring system 104 as compared to the three (3) entities 110-1, 110-2, and 110-4 detected in the zone 102. In the example illustrated in FIG. 7, the entity 110-4 corresponds to the non-authorized entity without any authenticated electronic device.

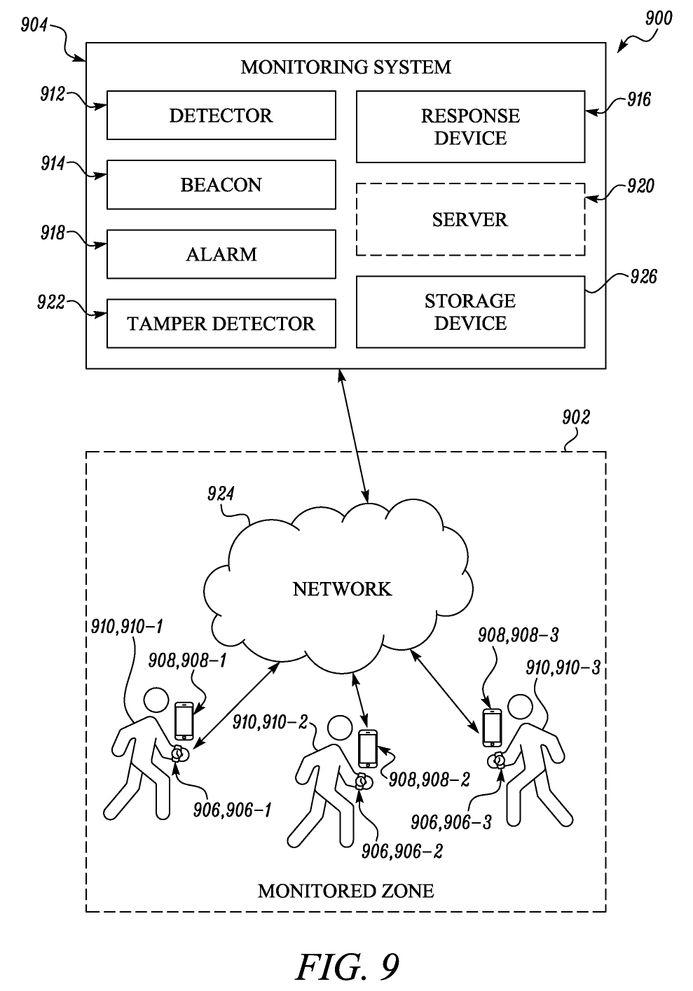

Referring to FIG. 9, an exemplary system 900 for authorizing presence of at least one entity 910 in at least one zone 902 is illustrated. The zone 902 corresponds to any designated area or space that is defined by one or more specific purposes, one or more characteristics, and/or one or more regulations. For example, the zone 902 includes one or more of a residential area (such as, but not limited to, a house, an apartment, and/or a surrounding area), a sterile medical zone (such as, but not limited to, an operating room, an emergency room), a natural area (such as, but not limited to, a forest, or a wildlife reserve), a government area (such as, but not limited to, a military base, a government building, or an embassy), a public area (such as, but not limited to, a park, a bank, a hospital, or a shopping mall), an industrial area (such as, but not limited to, a factory, an office or office building, a data center, an industrial hazard zone, or a warehouse), an agricultural area (such as, but not limited to a farmland), or a specialized area (such as, but not limited to, an airport, a secure defense facility, or a border control zone) with controlled access, or any such residential, enterprise, or commercial area. The zone 902 is defined by one or more of: physical boundaries (such as, walls, doors, or corridors), virtual boundaries defined by coordinates within a space, sensor-defined boundaries (such as, infrared trip lines or Light Detection and Ranging (LiDAR)), software-defined boundaries, time-based boundaries, dynamically defined boundaries, or any other manner of defining the boundaries now known or developed in future. In some embodiments, the zone 902 is dynamic and is defined and/or modified depending upon the requirement of the system 900. Further, although not shown, the system 900 can include multiple zones 902 having distinct authorization requirements and responses. In accordance with various embodiments, the entity 910 corresponds to a human, an animal, or any other entity (now known or in the future developed) from which biometric data can be obtained. As shown in FIG. 9, the zone 902 simultaneously contains multiple entities 902, each associated with distinct authorization permissions.

In accordance with various embodiments, the entity 910 is configured to be permitted to be present in the zone 902 depending upon an authorization time window associated with the entity 910. The authorization time window defines the period during which the entity 910 is permitted to be present in the zone 902. For example, in an embodiment, the authorization time window includes a start time indicating when permission begins and/or an end time indicating when permission expires. In some embodiments, the authorization time window is derived from external scheduling systems, including personnel schedules, shift-based authorization, access management systems, robotics fleet management platforms, or hospital scheduling systems.

The system 900 includes at least one monitoring system 904, a first electronic device 906 (for example, but not limited to, the first electronic devices 906-1, 906-2, and 906-3), and a second electronic device 908 (for example, but not limited to, the second electronic devices 908-1, 908-2, and 908-3). In accordance with various embodiments, the first electronic devices 906 and the second electronic devices 908 are associated with the corresponding entities 910. For example, as illustrated in FIG. 9, the first electronic device 906-1 and the second electronic device 908-1 are associated with the entity 910-1, the first electronic device 906-2 and the second electronic device 908-1 are associated with the entity 910-2, and the first electronic device 906-3 and the second electronic device 908-3 are associated with the entity 910-3. The monitoring system 904, the first electronic device 906, and the second electronic device 908 are communicatively coupled to each other via a communication network 924 (referred also interchangeably as network 924). The network 924 is a secure network including, but not limited to, a Local Area Network (LAN), a Wireless Local Area Network (WLAN), a Wireless Personal Area Network (WPAN), a Small Area Network (SAN), a telecommunication network including, but not limited to, a fourth generation (4G), a fifth generation (5G) cellular network, a Near Field Communication (NFC) network, and other wireless communication networks employing infra-red beams/signals, radio frequency (RF) signals, or other forms of wireless communication, and utilizing any of a variety of communications protocols, as is now known or in the future developed.

In accordance with various embodiments, the monitoring system 904 is configured to detect an occurrence of a triggering event associated with the entity 910 and transmit a credential authentication request in response to the occurrence of the triggering event. The monitoring system 904 is configured to receive a response (for example, encrypted identity credentials of the entity 910), via the first electronic device 906. In absence of the response from the first electronic device 906 within a predetermined time interval or a failure to authenticate the first electronic device 906 based on the response or detection of a tampering event at the first electronic device 906, the monitoring system 904 is configured to trigger a fallback authentication sequence to authorize the presence of the entity 910 in the zone 902. For example, the monitoring system 904 is configured to transmit a biometric authentication request on the second electronic device 908 and authorize the presence of the entity 910 based on biometric data received in response to the biometric authentication request (described in detail below).

In accordance with various embodiments, the triggering event includes one or more of: a geofence entry of the entity 910 within the zone 902, an input received on the first electronic device 906 to authenticate the first electronic device 906, or an expiration of a preset time interval for authorizing presence of the entity 910 in the zone 902. The credential authentication request corresponds to any authentication request transmitted by the monitoring system 904 that prompts the first electronic device 906 to identify the entity 910. The identity credentials transmitted in response to the credential authentication request correspond to any data or artifacts used to identify the entity 910. For example, the identity credentials include, but are not limited to, passwords, PINs, security questions, digital certificates, digital tokens, or any data identifying the identity of the entity 910 now known or developed in future. Further, the biometric authentication request corresponds to a request to capture and transmit unique biological data of the entity 910. For example, the biological data includes, but is not limited to, fingerprints, facial scans, voice pattern, vein pattern, electrocardiogram signatures, iris pattern, skin impedance, gait signatures, oxygenation profiles, or any other biological data or behavioral trait for identity verification of the entity 910.

The various components of the monitoring system 904 will now be described hereinafter with respect to FIG. 9. It should be appreciated by those of ordinary skill in the art that FIG. 9 depicts the monitoring system 904 in a simplified manner and a practical embodiment includes additional components and suitably configured logic to support known or conventional operating features that are not described in detail herein. Although the monitoring system 904 is illustrated and described to be implemented within a single device, it is contemplated that the one or more components of the monitoring system 904 are alternatively implemented in a distributed computing environment, without deviating from the scope of the claimed subject matter. It will further be appreciated by those of ordinary skill in the art that one or more components of the monitoring system 904 alternatively functions within a remote server, cloud computing device, or any other remote computing mechanism now known or developed in the future.

The monitoring system 904 includes at least one detector 912, at least one beacon 914, an alarm 918, at least one tamper detector 922, a server 920, a response device 916, and a storage device 926. The components of the monitoring system 904, including the detector 912, the beacon 914, the alarm 918, the tamper detector 922, the server 920, the response device 916, and the storage device 926 are communicatively coupled with one another to enable operations of the monitoring system 904. In accordance with various embodiments when the components of the monitoring system 904 are implemented within a single device, each component communicates with one another via a monitoring system local interface (not illustrated). The monitoring system local interface includes, but is not limited to, one or more buses or other wired or wireless connections, as is known in the art. The monitoring system local interface includes additional elements, which are omitted for simplicity, such as controllers, buffers (caches), drivers, repeaters, and receivers, among many others, to enable communications. Further, the monitoring system local interface includes address, control, and/or data connections to enable appropriate communications among the aforementioned components.

Although not shown, in some embodiments, the functions of the monitoring system 904 are performed by one or more other components (not shown) of the monitoring system 904, including but not limited to a control panel, edge controller, local gateway, distributed processing node, or remote or cloud-based system. Such functioning can be centralized or distributed and can be performed synchronously or asynchronously. As used herein, the term monitoring system 904 encompasses any such configuration.

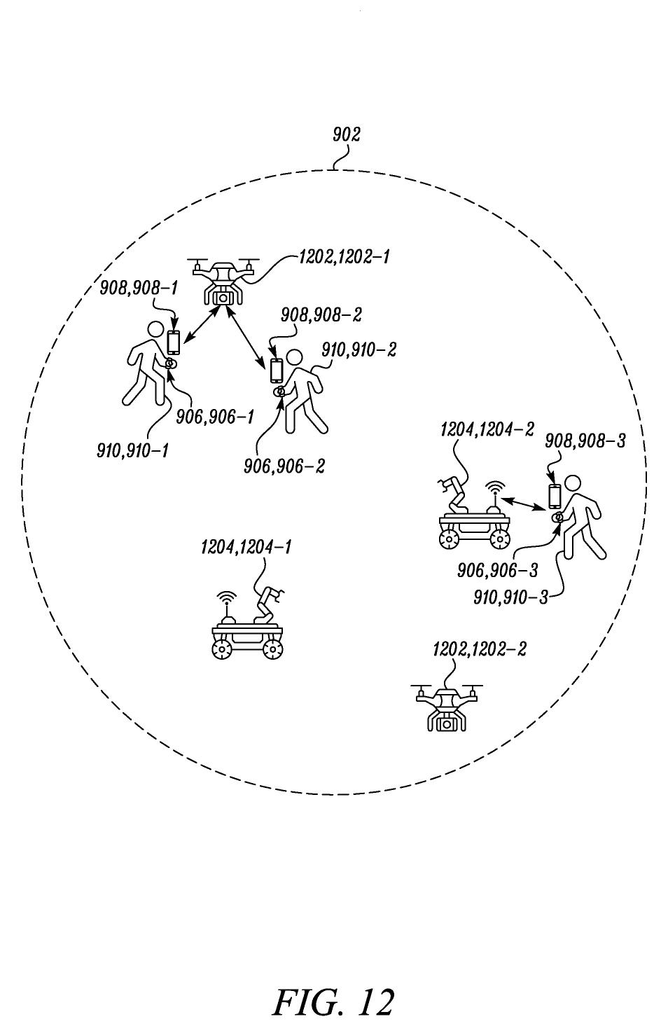

In some embodiments, the one or more components of the monitoring system 904 are implemented in a distributed manner in a plurality of devices. In an embodiment shown in FIG. 12, the monitoring system 904 includes a plurality of drones 1202 (for example, the drones 1202-1 and 1202-2) and/or a plurality of robotic ground units 1204 (for example, the robotic ground units 1204-1 and 1204-2) deployed in the zone 902. Each device 1202, 1204 is configured to include one or more components (such as, the detector 912, the beacon 914, the alarm 918, the tamper detector 922, the server 920, the response device 916, and/or the storage device 926) of the monitoring system 904 to perform one or more functions of the monitoring system 904. Furthermore, the devices 1202, 1204 are communicatively coupled with each other to propagate information associated with the authorization or non-authorization of the entity 910 in the zone 902. Although not shown, a person skilled in the art would appreciate that the devices 1202, 1204 are not limited to the drones 1202 and the robotic ground units 1204, and that the embodiments described in the present description can include other devices capable of performing the functioning of the monitoring system 904.

Referring back to FIG. 9, the detector 912 corresponds to the detector 112 described above with reference to FIGS. 1 and 2. Additionally, in this embodiment, the detector 912 is configured to detect the occurrence of the triggering event and send a signal to the beacon 914 to transmit the credential authentication request in response to the occurrence of the triggering event. In an embodiment, the detector 912 corresponds to any motion detection device configured to detect the geofence entry, the presence, a movement, a spatial change, an occupancy, a trajectory, or an environmental variation within the zone 902. It would be appreciated by a person skilled in the art that the detector 912 includes any sensing modality now known or later developed, including but not limited to passive or active sensing technologies. For example, the detector 912 corresponds to one or more of: an infrared sensor, a passive infrared (PIR) sensor, a microwave sensor, a radar-based sensor, a millimeter-wave sensor, a radio-frequency (RF) sensor, an ultra-wideband (UWB) sensor, a Light Detection and Ranging (LiDAR) system, a structured-light system, a time-of-flight sensor, a stereoscopic or depth-mapping sensor, a tomographic sensing system, a radio-frequency imaging system, an acoustic or ultrasonic sensor, a magnetic sensor, a pressure sensor, a capacitive sensor, an optical sensor, a camera-based system, an optical trip-line, or any device with motion detection mechanism, now known or developed in future, to detect the geofence entry and/or the presence of the entity 910 within the zone 902.

In some embodiments, the detector 912 includes distributed or networked sensing systems configured to infer the presence, the movement, or the spatial change based on changes in electromagnetic propagation, signal attenuation, reflection, diffraction, phase, latency, or interference patterns within the zone 902. Such systems include, without limitation, sensing architectures utilizing cellular, wireless, or near-field communication infrastructures, including those operating under current or future generations of wireless standards, such as fifth-generation (5G), sixth-generation (6G), or later-developed communication protocols.

In some embodiments, the detector 912 operates as part of a volumetric, topographical, or environmental sensing framework, generating or inferring spatial models, occupancy maps, boundary conditions, or dynamic representations of the monitored zone 902. In such embodiments, the detection of movement and/or presence of the entity 910 is based on absolute measurements, relative changes, inferred conditions, probabilistic models, or machine-learned interpretations derived from one or more sensor inputs. It would be appreciated by a person skilled in the art that regardless of sensing modality, implementation, or underlying technology, the detector 912 is configured to generate one or more detection signals which are provided to one or more components of the monitoring system 904 to initiate the one or more functions as described in detail below.

The components of the detector 912 correspond to the corresponding one or more components of the detector 112 described above with reference to FIGS. 1 and 2. Additionally, in this embodiment, the detector transceiver 132 is configured to send the signal to the beacon 914 to transmit the credential authentication request in the zone 902 in response to the occurrence of the triggering event and receive the response (for example, the encrypted identity credentials of the entity 910) from the first electronic device 906 associated with the entity 910 in the zone 902. In some embodiments, the detector transceiver 132 is configured to receive a network message corresponding to the input received on the first electronic device 906 via the beacon 914. In some embodiments, the detector transceiver 132 is configured to transmit data associated with the triggering event to the server 920. For example, the data associated with the triggering event includes data (for example, but not limited to, temperature data, visual image data, thermal image data or any other motion detection data now known or in the future developed) associated with the zone 902 for detecting the geofence entry and/or presence of the entity 910 within the zone 902, the network message corresponding to the input received from the first electronic device 906, and the preset time interval for authorizing the geofence entry and/or presence of the entity 910 in the zone 902. Additionally, in this embodiment, the detector memory 136 is configured to store data associated with the triggering event, the preset time interval, a predetermined temperature threshold value, and a predetermined thermal threshold value. In some embodiments, the detector memory 136 is configured to store an authorization state and a presence state of each entity 910 in the zone 902. The authorization state of an entity (for example, the entity 910) indicates whether the entity 910 is authorized to be present and/or move within the zone 902 or not, and the presence state of the entity 910 indicates whether the entity 910 is present in the zone 902 or not.

Additionally, in this embodiment, the sensor 138 is configured to monitor a physical area corresponding to the zone 902 to detect the geofence entry and/or presence of the entity 910 within the zone 902. To this end, the sensor 138 is configured to capture data associated with changes in the zone 902 that indicates the geofence entry and/or presence of the entity 910 within the zone 902. In an embodiment, the sensor 138 corresponds to an infra-red sensor configured to measure infrared radiations within the zone 902 to detect changes in temperature of the zone 902. As known in the art, when an entity (for example, the entity 910) enters the zone 902, the infra-red radiations (for example, the heat) from the entity 910 within the zone 902 change the temperature of the zone 902. The infra-red sensor is configured to measure these changes in the infrared radiations in the zone 902. The detector processor 134 or the server 920 (shown in FIG. 9) is configured to obtain data associated with the temperatures of the zone 902 and/or changes in the infrared radiations in the zone 902 measured by the infra-red sensor, and determine the geofence entry and/or presence of the entity 910 in the zone 902 when the change in the temperature (interchangeably referred to as the temperature data) of the zone 902 is greater than a predetermined temperature threshold value during a predefined time interval. In accordance with various embodiments, the predefined time interval is a predetermined pre-programmed interval of time. It would be appreciated by a person skilled in the art that although the sensor 138 is described as the infra-red sensor, the sensor 138 in some embodiments, includes an ultrasonic sensor, a microwave sensor, a radar sensor, a Light Detection and Ranging (LiDaR), a pressure sensor, an optical trip-line, a proximity sensor, or any other motion detection sensor known in the art or developed in the future.

Additionally, in some embodiments, the sensor 138 also includes an infra-red camera configured to measure infrared radiations within the zone 902 and convert the measured infrared radiations into a thermal image. The infra-red camera is further configured to determine changes in the heat pattern between two or more thermal images captured between the predefined time interval, for example, using one or more motion detection algorithms and detect the geofence entry and/or presence of the entity 910 in the zone 902 when the changes in the heat pattern between the two or more thermal images (interchangeably referred to as the thermal image data) is greater than the predetermined thermal threshold value. In some embodiments, the detector processor 134 or the server 920 is configured to obtain the two or more thermal images from the infra-red camera and determine the geofence entry and/or presence of the entity 910 in the zone 902 when the changes or differences in the heat pattern between the two or more thermal images is greater than the predetermined thermal threshold value. It would be appreciated by a person skilled in the art that although the sensor 138 is described as the infra-red camera, the sensor 138 includes any motion detection camera known in the art or developed in the future.

For example, in an embodiment, the sensor 138 corresponds to a camera configured to capture one or more visual images of the zone 902. The camera corresponds to any image capturing device, such as monochrome digital cameras, high-resolution digital cameras, or any suitable digital cameras. For example, the camera includes, but is not limited to, one or more of a still camera, a camcorder, a video camera, a Closed-Circuit Television (CCTV) camera, or any device now known or in the future developed to capture images of the zone 902. In accordance with various embodiments, the sensor 138 is configured to transmit data associated with the visual images (interchangeably referred to as the visual image data) to the server 920 or the detector processor 134 for detecting the geofence entry of the entity 910 within the zone 902. The server 920 or the detector processor 134 is configured to process the visual image data, using various image processing techniques now known or developed in the future, to detect the geofence entry and/or presence of the entity 910 within the zone 902.

Additionally, in this embodiment, the detector processor 134 is configured to obtain data, for example, the temperature data, the visual image data, the thermal image data from the sensor 138 and determine the geofence entry and/or the presence of the entity 910 in the zone 902 based on the obtained data using the same process as described above. In some alternate embodiments, the detector transceiver 132 is configured to transmit the temperature data, the visual image data, the thermal image data captured by the sensor 138 to the server 920 for detecting the geofence entry and/or presence of the entity 910 in the zone 902 (using the same process as described above).

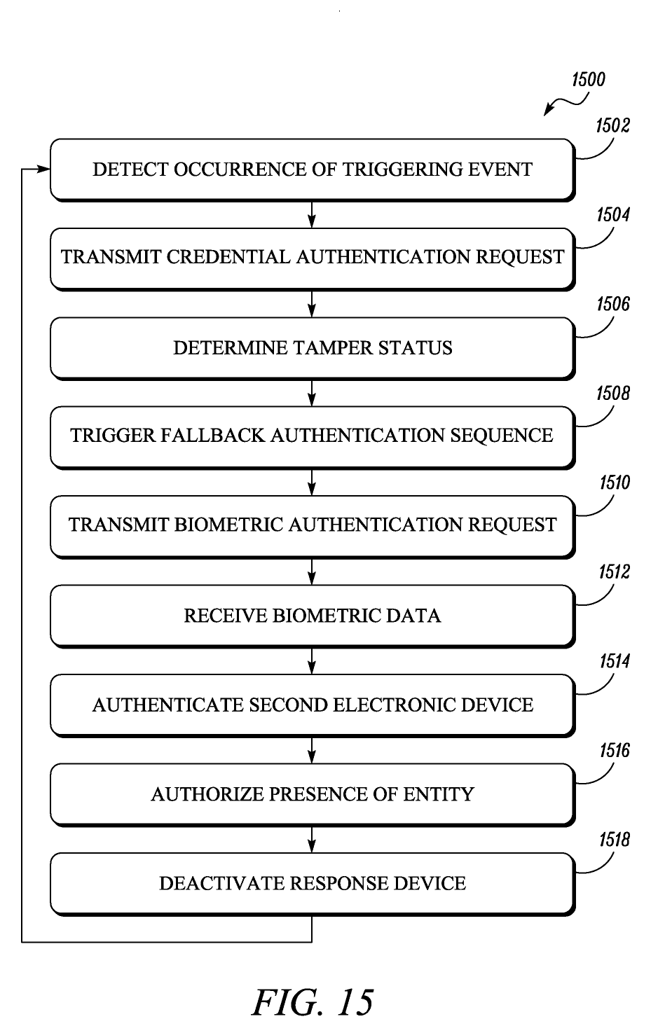

Additionally, in this embodiment, the detector processor 134 is configured to determine the expiration of the preset time interval for authorizing the geofence entry and/or presence of the entity 910 in the zone 902. The detector processor 134 is configured to obtain data regarding the preset time interval from the detector memory 136 or the server 920, and compute an expiry time by adding the preset time interval to a start time, such as the current time at computation. The detector processor 134 is then configured to periodically compare the expiry time against the current time at comparison, and determine the expiration of the preset time interval when the current time is greater than and/or equal to the expiry time. In some embodiments, the server 920 is configured to determine the expiration of the preset time interval and send a signal to the detector processor 134 on the expiry. In accordance with various embodiments, on expiry of the preset time interval, the detector processor 134 or the server 920 is configured to restart a new time interval corresponding to the preset time interval to repeat the method 1500 (described below with respect to FIG. 15). The preset time interval is a predetermined pre-programmed interval of time. In some embodiments, the preset time interval is defined based on the authorization time window of the entity 910. For example, the detector processor 134 or the server 920 is configured to determine or adjust the preset time interval to the shortest remaining time obtained from authorized time windows of the authorized entities 910 in the zone 902, to prevent unauthorized stay of the entities 910 beyond their respective authorization time windows. In accordance with various embodiments, on expiry of the preset time interval, the detector processor 134 or the server 920 is configured to restart a new time interval corresponding to the preset time interval or corresponding to a different preset time interval.

Additionally, in this embodiment, the detector processor 134 is configured to receive the network message corresponding to the input received from the first electronic device 906, via the beacon 914. Additionally, in accordance with various embodiment, the detector processor 134 or the server 920 is configured to instruct the beacon 914 to transmit the credential authentical request in the zone 902 in response to the occurrence of the triggering event.

In some embodiments, the detector processor 134 or the server 920 is configured to evaluate the authorization state of the entity 910 in the zone 902, upon detecting the presence and/or movement of the entity 910 in the zone 902. When the authorization state of the entity 910 indicates that the entity 910 is authorized to be present and/or move within the zone 902, the detector processor 134 or the server 920 is configured to permit the presence and/or movement of the entity 910 within the zone 902 without activating the alarm 118 and/or the response device 116. In such cases, the detector processor 134 or the server 920 continues monitoring the presence and/or movement of the entity 910 in the zone 902 while maintaining the authorization state as ‘authorized’ until the triggering event occurs. When the authorization state of the entity 910 indicates that the entity 910 is not authorized to be present and move within the zone 902, the detector processor 134 or the server 920 is configured to maintain the presence state of the entity 910 as ‘present’ indicating that the entity 910 is present within the zone 902 and the authorization state as ‘unauthorized’. The detector processor 134 or the server 920 is configured to initiate a response, including one or more of: activating the alarm 118, activating the response device 116, and/or transmitting the credential authentication request. Upon successful authentication, the detector processor 134 or the server 920 is configured to update the authorization state of the entity 910 as ‘authorized’ and authorize the presence and/or movement of the entity 910 within the zone 902 without further response.

Furthermore, in some embodiments, when the entity 910 is detected within the zone 902, the detector processor 134 or the server 920 is configured to maintain the presence state of the entity 910 as ‘present’. The detector processor 134 or the server 920 is further configured to evaluate the authorization state of the entity 910. When the authorization state of the entity 910 is ‘authorized’ indicating that the entity 910 is authorized to move within the zone 902 for a defined time period, the detector processor 134 or the server 920 is configured to permit the movement of the entity 910 within the zone 902 without activating the alarm 118 and/or the response device 116 for the defined time period. In such cases, the detector processor 134 or the server 920 continues monitoring the presence of the entity 910 in the zone 902. When the entity 910 is present in the zone 902 after the defined time period, the detector processor 134 or the server 920 is configured to initiate a response, including activating the alarm 118, activating the response device 116, and/or re-transmitting the credential authentication request. In such cases, the presence state of the entity 910 remains unchanged as ‘present’. Upon successful re-authentication, the authorization state is renewed, for example, for the same or different time periods, and the movement of the entity 910 within the zone 902 is again permitted.

Referring back to FIG. 9, the beacon 914 is configured to transmit and/or receive data/signal from the first electronic device 906, the second electronic device 908 within the zone 902, and one or more components of the monitoring system 904. In accordance with various embodiments, the range of the beacon 914 is configured to ensure coverage of the entire zone 902. In some embodiments, the range of the beacon 914 is geographically constrained to the zone 902. The various components of the beacon 914 correspond to the one or more components of the beacon 114 as described above with reference to FIGS. 1 and 3. Additionally, in this embodiment, the beacon transceiver 144 is configured to transmit the credential authentication request in the zone 902 in response to the signal from the detector 912 and receive the response (for example, the encrypted identity credentials of the entity 910) from the first electronic device 906 in the zone 902. Additionally, the beacon transceiver 144 is configured to transmit the biometric authentication request upon receiving a signal from the server 920 and receive the biometric data of the entity 910 from the second electronic device 908 associated with the entity 910 in response to the biometric authentication request. Additionally, in some embodiments, the beacon transceiver 144 is configured to receive the network message corresponding to the input received on the first electronic device 906 and provide the network message to the detector 912 and/or the server 920.

The beacon processor 148 is configured to cooperate with other components of the beacon 914 to perform its operations. Additionally, in this embodiment, the beacon processor 148 is configured to control the beacon transceiver 144 to transmit the credential authentication request and the biometric authentication request to the first electronic device 906 and the second electronic device 908, respectively, and receive the encrypted identity credentials and the biometric data from the first electronic device 906 and the second electronic device 908, respectively.

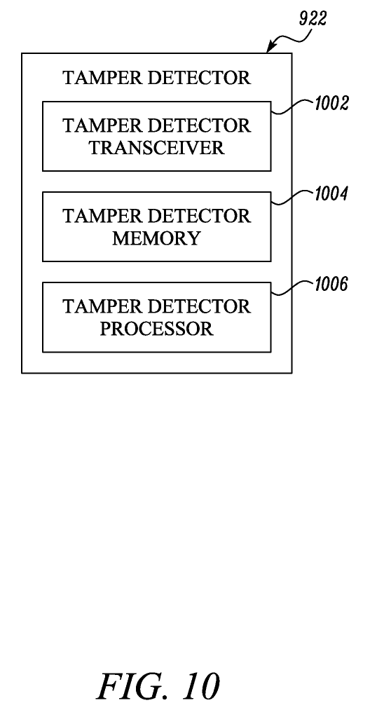

Referring back to FIG. 9, the tamper detector 922 is configured to periodically determine tamper status of the first electronic device 906 associated with the entity 910. The tamper detector 922 corresponds to any sensor device or a circuit now known or in the future developed to detect physical compromise of the first electronic device 906. The various components of the tamper detector 922 will now be described hereinafter with respect to FIG. 10. It should be appreciated by those of ordinary skill in the art that FIG. 10 depicts the tamper detector 922 in a simplified manner and a practical embodiment includes additional components and suitably configured logic to support known or conventional operating features that are not described in detail herein. Although the tamper detector 922 is illustrated and described to be implemented within a single communication device, it is contemplated that the one or more components of the tamper detector 922 are alternatively implemented in a distributed computing environment.

Referring to FIG. 10, the tamper detector 922 includes, among other components, a tamper detector transceiver 1002, a tamper detector memory 1004, and a tamper detector processor 1006. The components of the tamper detector 922, including the tamper detector transceiver 1002, the tamper detector memory 1004, and the tamper detector processor 1006 cooperate with one another to enable operations of the tamper detector 922. Each component communicates with one another via a tamper detector local interface (not illustrated). The tamper detector local interface includes, but is not limited to, one or more buses or other wired or wireless connections, as is known in the art. The tamper detector local interface includes additional elements, which are omitted for simplicity, such as controllers, buffers (caches), drivers, repeaters, and receivers, among many others, to enable communications. Further, the tamper detector local interface includes address, control, and/or data connections to enable appropriate communications among the aforementioned components.

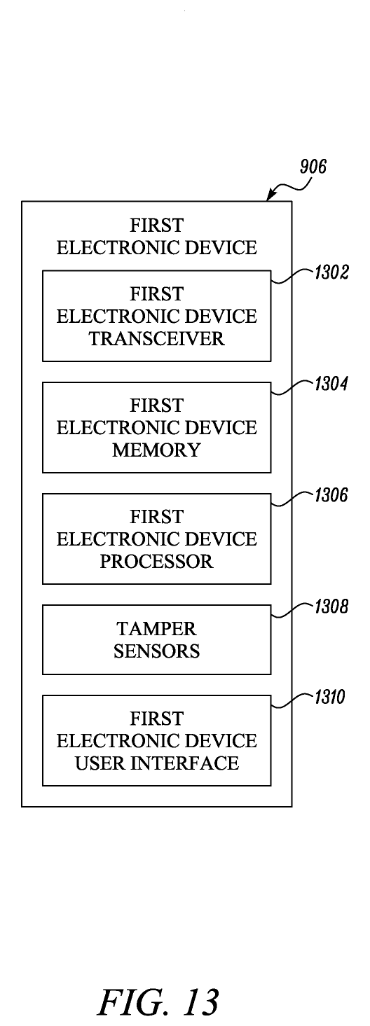

As illustrated, the tamper detector 922 includes the tamper detector transceiver 1002 to transmit data and/or signals to and receive data and/or signals from one or more tamper sensors 1308 (shown in FIG. 13) and/or one or more other components of the monitoring system 904, such as, the beacon 914 and the server 920. For example, the tamper detector transceiver 1002 is configured to receive tamper data from the tamper sensors 1308. In some embodiments, the tamper detector transceiver 1002 is configured to receive the tamper data via the beacon 914 of the monitoring system 904. Further, in some embodiments, the tamper detector transceiver 1002 is configured to transmit the received tamper data to the server 920. The tamper detector transceiver 1002 includes a transmitter circuitry and a receiver circuitry to enable the tamper detector 922 to communicate with the tamper sensors 1308 and the one or more other components of the monitoring system 904. In this regard, the transmitter circuitry includes appropriate circuitry to transmit the data and/or signals to the tamper sensors 1308 and the one or more other components and the receiver circuitry includes appropriate circuitry to receive the data and/or signals from the tamper sensors 1308 and the one or more other components. It will be appreciated by those of ordinary skill in the art that the tamper detector 922 includes a single tamper detector transceiver 1002 as illustrated, or alternatively separate transmitting and receiving components, for example but not limited to, a transmitter, a transmitting antenna, a receiver, and a receiving antenna. In some embodiments, when the components of the monitoring system 904 are implemented within a single device, the tamper detector 922 communicates with the one or more other components using any on-board communication, for example, the monitoring system local interface.

The tamper detector memory 1004 is a non-transitory memory configured to store a set of instructions that are executable by the tamper detector processor 1006 to perform predetermined operations. For example, the tamper detector memory 1004 includes any of the volatile memory elements (for example, random access memory (RAM)), non-volatile memory elements (for example, read only memory (ROM)), and combinations thereof. Moreover, the tamper detector memory 1004 incorporates electronic, magnetic, optical, and/or other types of storage media. In accordance with various embodiments, the tamper detector memory 1004, for example, is configured to store one or more threshold values (described in detail below) for detecting the tampering event at the first electronic device 906. The one or more threshold values are predetermined pre-programmed values.

The tamper detector processor 1006 is configured to execute the instructions stored in the tamper detector memory 1004 to perform the predetermined operations. The tamper detector processor 1006 includes one or more microprocessors, microcontrollers, DSPs (digital signal processors), state machines, logic circuitry, or any other device or devices that process information or signals based on operational or programming instructions. The tamper detector processor 1006 is implemented using one or more controller technologies, such as Application Specific Integrated Circuit (ASIC), Reduced Instruction Set Computing (RISC) technology, Complex Instruction Set Computing (CISC) technology, or any other similar technology now known or in the future developed. The tamper detector processor 1006 is configured to cooperate with other components of the tamper detector 922 to perform its operations (described in detail with reference to FIGS. 10 and 15).

The tamper detector processor 1006 is configured to receive the tamper data from the tamper sensors 1308 and compare the tamper data with the one or more threshold values to determine the occurrence of the tampering event at the first electronic device 906. In accordance with various embodiments, the tamper sensors 1308 are integrated into the first electronic device 906 (as described in detail with reference to FIG. 13). The tamper sensors 1308 include one or more of: a galvanic skin response (GSR) sensor, a clasp sensor, an orientation sensor, an impact sensor, a morphing material circuit, or any other sensor now know or developed in future for detecting physical compromise of the first electronic device 906. The tamper data corresponds to raw or processed signals generated by the tamper sensors 1308 for determining the tamper status of the first electronic device 906. For example, the tamper data includes a galvanic skin response (GSR) conductance signal from the GSR sensor, a proximity state signal from the clasp sensor, an orientation signal from the orientation sensor, an impact signal from the impact sensor, a resistance/capacitance change signal from the morphing material circuit, or any other raw or processed signals for determining the tamper status of the first electronic device 906. The tamper status of the first electronic device 906 is defined as secured (for example, when no tamper conditions are detected) or compromised (for example, when physical tampering is determined) based on the tamper data. The tamper detector processor 1006 is configured to determine the occurrence of the tampering event at the first electronic device 906 when the tamper status of the first electronic device 906 is determined as compromised. In some alternate embodiments, the tamper detector transceiver 1002 is configured to transmit the tamper data to the server 920 for determining the tamper status of the first electronic device 906 based on the tamper data (using the same process as described below).

When the tamper sensor 1308 corresponds to the GSR sensor, the tamper detector processor 1006 is configured to receive the GSR conductance signal from the GSR sensor as the tamper data and compares it with a GSR threshold value. The GSR threshold value is a predetermined pre-programmed GSR value. The tamper detector processor 1006 is configured to determine that the tamper status of the first electronic device 906 is compromised when one or more values associated with the GSR conductance signal from the GSR sensor exceed the GSR threshold value. Similarly, the tamper detector processor 1006 is configured to determine that the tamper status of the first electronic device 906 is secured when the one or more values associated with the GSR conductance signal from the GSR sensor are equal to or below the GSR threshold value.

When the tamper sensor 1308 corresponds to a clasp sensor, the tamper detector processor 1006 is configured to receive the proximity state signal from the clasp sensor as the tamper data and compares it with a proximity threshold value. The proximity threshold value is a predetermined pre-programmed proximity value. The tamper detector processor 1006 is configured to determine that the tamper status of the first electronic device 906 is compromised when one or more values associated with the proximity state signals exceed the proximity threshold value. Similarly, the tamper detector processor 1006 is configured to determine that the tamper status of the first electronic device 906 is secured when the one or more values associated with the proximity state signals are equal to or below the proximity threshold value.

When the tamper sensor 1308 corresponds to the orientation sensor, the tamper detector processor 1006 is configured to receive the orientation signal from the orientation sensor as the tamper data and compares it with an orientation threshold value. The orientation threshold value is a predetermined pre-programmed orientation value. The tamper detector processor 1006 is configured to determine that the tamper status of the first electronic device 906 is compromised when one or more values associated with the orientation signal exceed the orientation threshold value. Similarly, the tamper detector processor 1006 is configured to determine that the tamper status of the first electronic device 906 is secured when the one or more values associated with the orientation signal are equal to or below the orientation threshold value.

When the tamper sensor 1308 corresponds to the impact sensor, the tamper detector processor 1006 is configured to receive the impact signal from the impact sensor as the tamper data and compares it with an impact threshold value. The impact threshold value is a predetermined pre-programmed impact value. The tamper detector processor 1006 is configured to determine that the tamper status of the first electronic device 906 is compromised when one or more values associated with the impact signal exceed the impact threshold value. Similarly, the tamper detector processor 1006 is configured to determine that the tamper status of the first electronic device 906 is secured when the one or more values associated with the impact signal are equal to or below the impact threshold value.

When the tamper sensor 1308 corresponds to a morphing material circuit, the tamper detector processor 1006 is configured to receive the resistance/capacitance change signal from the morphing material circuit as the tamper data and compares it with a morphing threshold value. The morphing threshold value is a predetermined pre-programmed morphing value. The tamper detector processor 1006 is configured to determine that the tamper status of the first electronic device 906 is compromised when one or more values associated with the resistance/capacitance change signal exceed the morphing threshold value. Similarly, the tamper detector processor 1006 is configured to determine that the tamper status of the first electronic device 906 is secured when the one or more values associated with the resistance/capacitance change signal are equal to or below the morphing threshold value.

Referring back to FIG. 9, the server 920 is configured to authorize the presence of the entity 910 in the zone 902 based on the authentication of the first electronic device 906 and/or the second electronic device 908. In some embodiments, the server 920 is configured to control and/or instruct the one or more other components of the monitoring system 904 to perform their operations. For example, the server 920 is configured to control and/or instruct the detector 912 to detect the occurrence of the triggering event associated with the entity 910 within the zone 902. Similarly, the server 920 is configured to control the beacon 914 to transmit the credential authentication request in response to the occurrence of the triggering event and receive the encrypted identity credentials from the first electronic device 906 associated with the entity 910 in response to the credential authentication request. Further, the server 920 is configured to control and/or instruct the tamper detector 922 to periodically determine the tamper status of the first electronic device 906.

In accordance with various embodiments, the server 920 is also configured to trigger a fallback authentication sequence to authorize the presence of the entity 910 in the zone 902 in absence of the response to the credential authentication request from the first electronic device 906 within the predetermined time interval or the failure to authenticate the first electronic device 906 based on the response to the credential authentication request or detection of the tampering event at the first electronic device 906 based on the tamper status. The server 920 is configured to transmit the biometric authentication request, via the beacon 914, to the second electronic device 908 as the fallback authentication sequence to authorize the presence of the entity 910 in the zone 902 and receive, via the beacon 914, the biometric data of the entity 910. The server 920 is further configured to authenticate the entity 910 and/or the second electronic device 908 of the entity 910 based on the received biometric data, authorize the geofence entry and/or presence of the entity 910 in the zone 902 for the preset time interval upon the authentication, and deactivate the alarm 918 and/or the response device 916 based on the authorization.

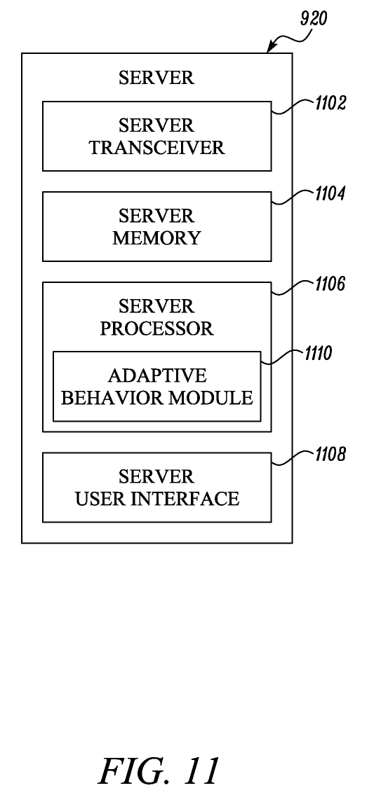

The various components of the server 920 will now be described hereinafter with respect to FIG. 11. It should be appreciated by those of ordinary skill in the art that FIG. 11 depicts the server 920 in a simplified manner and a practical embodiment includes additional components and suitably configured logic to support known or conventional operating features that are not described in detail herein. Although the server 920 is illustrated and described to be implemented within a single communication device, it is contemplated that the one or more components of the server 920 are alternatively implemented in a distributed computing environment. It will further be appreciated by those of ordinary skill in the art that one or more components of the server 920 alternatively functions within a remote server, cloud computing device, or any other remote computing mechanism now known or developed in the future.

Referring to FIG. 11, the server 920 includes, among other components, a server transceiver 1102, a server memory 1104, a server processor 1106, and a server user interface 1108. The components of the server 920, including the server transceiver 1102, the server memory 1104, the server processor 1106, and the server user interface 1108, cooperate with one another to enable operations of the server 920. Each component communicates with one another via a server local interface (not illustrated). The server local interface includes, but not limited to, one or more buses or other wired or wireless connections, as is known in the art. The server local interface includes additional elements, which are omitted for simplicity, such as controllers, buffers (caches), drivers, repeaters, and receivers, among many others, to enable communications. Further, the server local interface includes address, control, and/or data connections to enable appropriate communications among the aforementioned components.

As illustrated, the server 920 includes the server transceiver 1102 to transmit data/signals to and receive data/signals from the first electronic device 906, the second electronic device 908, and/or other components of the monitoring system 904. For example, the server transceiver 1102 is configured to transmit, via the beacon 914, the credential authentication request and the biometric authentication request to the first electronic device 906 and the second electronic device 908, respectively. The server transceiver 152 is further configured to receive, via the beacon 914, the encrypted identity credentials and/or the biometric data from the first electronic device 906 and the second electronic device 908, respectively. The server transceiver 152 is further configured to transmit a signal, via the beacon 914, to the alarm 918 and/or the response device 916 to deactivate or activate the alarm 918 and/or the response device 916 based on the authentication of the first electronic device 906 and/or the second electronic device 908. In some embodiments, the server transceiver 1102 is configured to receive the data associated with the triggering event from the detector 912 and initiate the transmission of the credential authentication request via the beacon 914 based on the received data. In some embodiments, the server transceiver 1102 is configured to receive the tamper data from the tamper detector 922 for determining the tamper status of the first electronic device 906. The server transceiver 1102 includes a transmitter circuitry and a receiver circuitry to enable the server 920 to communicate with the one or more devices and/or other components of the monitoring system 904. In this regard, the transmitter circuitry includes appropriate circuitry to transmit the data/signals to and the receiver circuitry includes appropriate circuitry to receive the data/signals from the one or more devices and/or other components of the monitoring system 904. It will be appreciated by those of ordinary skill in the art that the server 920 includes a single server transceiver 1102 as illustrated, or alternatively separate transmitting and receiving components, for example but not limited to, a transmitter, a transmitting antenna, a receiver, and a receiving antenna. In some embodiments, when the components of the monitoring system 904 are implemented within a single device, the server 920 communicates with the one or more other components using any on-board communication, for example, the monitoring system local interface.

The server memory 1104 is a non-transitory memory configured to store a set of instructions that are executable by the server processor 1106 to perform predetermined operations. For example, the server memory 1104 includes any of the volatile memory elements (for example, random access memory (RAM)), non-volatile memory elements (for example, read only memory (ROM)), and combinations thereof. Moreover, the server memory 1104 incorporates electronic, magnetic, optical, and/or other types of storage media. In accordance with various embodiments, the server memory 1104 is configured to store the predetermined temperature threshold value and the predetermined thermal threshold value for detecting the geofence entry and/or presence of the entity 110 within the zone 102. In some embodiments, the server memory 1104 is configured to store at least one key (for example, a public key) to decrypt the encrypted identity credentials of the entity 910 received from the first electronic device 906, the identity credentials and the biometric data of the entity 910 for authentication of the first electronic device 906 and the second electronic device 908, respectively, the one or more threshold values (for example, the GSR threshold value, the proximity threshold value, the orientation threshold value, the impact threshold value, and the morphing threshold value) for detecting the tamper status of the electronic device 906, and authorization time window of the entity 910.

In accordance with various embodiments, the server user interface 1108 is configured to receive inputs from and/or provide the outputs to the user and/or the programmer. The inputs are provided via a touch screen display, a camera, a touch pad, a keyboard, a microphone, a recorder, a mouse, or any other user input mechanism now known or developed in the future. The outputs are provided via a display device, a speaker, a haptic output, or any other output mechanism now known or developed in the future. The server user interface 1108 further includes one or more of a serial port, a parallel port, an infrared (IR) interface, a universal serial bus (USB) interface, and/or any other interface herein known or developed in the future. In accordance with various embodiments, the server user interface 1108 is configured to define and/or modify the triggering event, the tampering event, and the fallback authentication sequence.

The server processor 1106 is configured to execute the instructions stored in the server memory 1104 to perform the predetermined operations. In some embodiments, the server processor 1106 is configured to determine the occurrence of the triggering event based on the received data associated with the triggering event and transmit, via the beacon 914, the credential authentication request in the zone 902. The server processor 1106 is further configured to authenticate the first electronic device 906 based on the received encrypted identity credentials of the entity 910 and authorize the geofence entry and/or the presence of entity 910 upon the authentication of the corresponding first electronic device 906. The server processor 1106 is further configured to deactivate the alarm 918 and/or the response device 916 when the entity 910 is authorized to be present or enter the zone 902. Alternatively, the server processor 1106 is configured to activate the alarm 918 and/or the response device 916 when the entity 910 is not authorized to be present or enter the zone 902. Additionally, in some embodiments, the server processor 1106 is configured to determine the tamper status of the first electronic device 906 based on the received tamper data (using the process as described above).

In accordance with various embodiments, the server processor 1106 is configured to trigger the fallback authentication sequence to authorize the geofence entry and/or presence of the entity 910 in the zone 902 in absence of a reception of the encrypted identity credentials from the first electronic device 906 within a predetermined time interval or a failure to authenticate the first electronic device 906 based on the encrypted identity credentials received from the first electronic device 906 or detection of the tampering event at the first electronic device 906 based on the tamper status. To this end, the server processor 1106 is configured to instruct or control the beacon 914 to transmit the biometric authentication request as the fallback authentication sequence to the second electronic device 908 associated with the user to authorize the geofence entry and/or presence of the entity 910 in the zone 902. The server processor 1106 is then configured to receive, via the beacon 914, the biometric data of the entity 910 from the second electronic device 908 and authenticate the entity 910 based on the received biometric data. The server processor 1106 is further configured to authorize the presence of the entity 910 for the preset time interval upon the authentication. The server processor 1106 is further configured to deactivate the alarm 918 or the response device 916 based on the authorization and/or activate the alarm 918 or the response device 916 upon non-receipt of the biometric data within the predefined time interval or a failure of the authentication of the second electronic device 908. In accordance with various embodiments, the server processor 1106 is configured to authorize the presence or deactivate the alarm 918 or the response device 916 for the preset time interval. The preset time interval is any time duration predetermined by the programmer or the user of the monitoring system 904.

In some embodiments, the server processor 1106 includes an adaptive behavior module 1110 including an artificial intelligence engine configured to monitor behavior patterns of the entity 910 and dynamically adjust the triggering event, the tampering event, and the fallback authentication sequence in response to anomalies in the monitored behavior patterns. In accordance with various embodiments, the behavior patterns correspond to observable, repeatable patterns associated with an interaction of an entity (for example, the entity 910) with a zone (for example, the zone 902), and one or more associated electronic devices (for example, the first and second electronic devices 906, 908). The behavior patterns include, but are not limited to, frequency and timing of movement within a zone, zone entry and exit sequences, duration of presence within a specific zone, consistency of transmission of encrypted identity credentials associated with detected movements, historical authorization outcomes associated with the entity, device proximity patterns relative to detected motion events, or any such behavioral events. The anomalies in the monitored behavior patterns correspond to any deviation from one or more established behavioral patterns for the corresponding entity (for example, the entity 910). Such deviations include, but are not limited to, unexpected zone transitions (e.g., entry into a restricted zone), an abnormal timing or frequency of movement, a degraded signal consistency, delayed authentication responses, a movement detected without an expected corresponding device response, patterns consistent with device removal, spoofing, or tampering, or other such behavior deviations.

In accordance with various embodiments, the server processor 1106 is configured to adjust the triggering event, the tampering event, and the fallback authentication sequence for an entity 910 based on a confidence score of the entity 910. The confidence score is derived from parameters including one or more of: successful receipt and validation of encrypted identity credentials, consistency between detected movement and response timing, historical reliability of the associated electronic device 906, 908, behavioral consistency relative to prior authorized events, and absence of tamper indicators or signal anomalies. The confidence score is calculated as weighted aggregates or rule-based evaluations of the indicated parameters. When the server processor 1106 receives the encrypted identity credentials from the first electronic device 906 within a defined time duration and authenticates the first electronic device 906 based on the received encrypted identity credentials, the adaptive behavior module 1110 is configured to assign a first confidence score greater than a first threshold to the entity 910 based on a timely response, behavioral consistency, and historical authorization success. In such cases, the adaptive behavior module 1110 is configured to adjust the triggering event, the tampering event, and the fallback authentication sequence for the entity 910 based on the first confidence score. For example, the adaptive behavior module 1110 is configured to increase the preset time interval for the triggering event, increase the one or more threshold values (for example, the GSR threshold value, the proximity threshold value, the orientation threshold value, the impact threshold value, and the morphing threshold value) for detecting the tamper status of the electronic device 906, and/or delays triggering of the fallback authentication sequence. In such cases when the entity 910 is authenticated, the server processor 1106 is configured to authorize the presence and/or movement of the entity 910 in the zone 902 and deactivate the alarm 918 and/or response device 916.

When a subsequent movement of the entity 910 is detected and the transmission of the encrypted identity credentials from the first electronic device 906 is delayed, the adaptive behavior module 1110 is configured to reduce the confidence score associated with the entity 910 to a second confidence score below a secondary threshold. In such cases, the adaptive behavior module 1110 is configured to adjust the triggering event, the tampering event, and the fallback authentication sequence for the entity 910 based on the second confidence score. In an embodiment, the adaptive behavior module 1110 is configured to decrease the preset time interval for the triggering event and/or decrease the one or more threshold values (for example, the GSR threshold value, the proximity threshold value, the orientation threshold value, the impact threshold value, and the morphing threshold value) for detecting the tamper status of the electronic device 906. For example, the server processor 1106 is configured to permit the presence and/or movement of entry 910 in the zone 902 and flag the event as conditionally authorized. Such continuous degradation in the configured score triggers early fallback authentication.

In some embodiments, the server processor 1106 (hereinafter interchangeably referred to as a processor or at least one processor of the monitoring system 904) corresponds to the detector processor 134 associated with the detector 912 to detect the occurrence of the triggering event and/or the beacon processor 148 associated with the beacon 914 to transmit the credential authentication request based on the occurrence of the triggering event. In such cases, the server processor 1106 is configured to receive, via the server transceiver 1102, the data associated with the triggering event from the detector transceiver 132 of the detector 912 and detect the occurrence of the triggering event based on the received data. The server processor 1106 is further configured to initiate the transmission of the credential authentication request via the beacon transceiver 144 of the beacon 914, for example, in response to the occurrence of the triggering event.

In some embodiments, the server processor 1106 corresponds to the tamper detector processor 1006 associated with the tamper detector 922 to detect the tampering event and/or the beacon processor 148 associated with the beacon 914 to transmit the biometric authentication request. In such cases, the server processor 1106 is configured to receive, via the server transceiver 1102, the tamper data associated with the tampering event from the tamper detector transceiver 1002 of the tamper detector 922 and detect the occurrence of the tampering event at the first electronic device 906 based on the received tamper data. The server processor 1106 is further configured to initiate the transmission of the biometric authentication request via the beacon transceiver 144 of the beacon 114, for example, in response to the detection of the triggering event.

The server processor 1106 includes one or more microprocessors, microcontrollers, DSPs (digital signal processors), state machines, logic circuitry, or any other device or devices that process information or signals based on operational or programming instructions. The server processor 1106 is implemented using one or more controller technologies, such as Application Specific Integrated Circuit (ASIC), Reduced Instruction Set Computing (RISC) technology, Complex Instruction Set Computing (CISC) technology, or any other similar technology now known or in the future developed. The server processor 1106 is configured to cooperate with other components of the server 920 to perform its operations (described in detail with reference to FIG. 15).

Referring back to FIG. 1, the response device 116 and/or the alarm 118 is configured to be activated or deactivated by the server 120 based on one or more signals/instructions received from the server 120. For example, the response device 116 and/or the alarm 118 is configured to be activated when an unauthorized entry of the entity 110 is detected within the zone 102. Similarly, the response device 116 and/or the alarm 118 is configured to be deactivated when an authorized entry of the entity 110 is detected within the zone 102. In accordance with various embodiments, when the server 120 authenticates the electronic device 106 and authorizes the movement of the entity 110 associated with the electronic device 106, the server 120 deactivates the response device 116 and/or the alarm 118. Similarly, the server 120 activates the alarm 118 and/or the response device 116 upon non-receipt of the second encrypted wireless signal within the predefined time duration or a failure of the authentication of the electronic device 106.

Referring back to FIG. 9, the storage device 926 is configured to store data associated with one or more of: the triggering event, the tampering event, and the fallback authentication sequence described above. In accordance with various embodiments, the storage device 926 is configured to obtain the data from the user and/or the programmer, for example, via the server user interface 1108 (shown in FIG. 11). In some embodiments, the storage device 926 is configured to obtain data from the one or more other components of the monitoring system 904. The storage device 926 corresponds to one or more of: a cloud server, an on-site storage device, or a decentralized blockchain ledger. Although not shown, in some embodiments, the storage device 926 is included in the server 920 or one or more other components of the monitoring system 904.

Referring back to FIG. 9, the response device 916 and/or the alarm 918 is configured to be activated or deactivated by the server 920 based on one or more signals/instructions received from the server 920. For example, the response device 916 and/or the alarm 918 is configured to be activated when an unauthorized geofence entry and/or unauthorized presence of the entity 910 is detected within the zone 902. Similarly, the response device 916 and/or the alarm 918 is configured to be deactivated when an authorized entry and/or presence of the entity 910 is detected within the zone 902. In accordance with various embodiments, when the server 920 authenticates the first electronic device 906 and/or the second electronic device 908 of the entity 910 and authorizes the movement of the entity 910, the server 920 deactivates the response device 916 and/or the alarm 918. Similarly, the server 920 activates the alarm 918 and/or the response device 916 upon non-receipt of the biometric data from the second electronic device 908 within the predetermined time interval or the failure to authenticate the second electronic device 908 based on the biometric data.

The response device 916 corresponds to any device capable of providing alerts associated with an unauthorized geofence entry and/or unauthorized presence of the entity 910 within the zone 902. In accordance with various embodiments, the response device 916, when activated, is configured to initiate a safety procedure, trigger an alert, and/or send communication to the other devices regarding unauthorized geofence entry and/or unauthorized presence of the entity 910 in the zone 902. For example, the response device 916 includes one or more of a display capable of providing visual alerts, a communication device capable of sending messages, an audio device capable of providing audio alerts or any other device known in the art or developed in the future to provide one or more types of alerts to one or more users of the monitoring system 904. In some embodiments, the response device 916 is configured to instruct one or more electronic devices (for example, the first electronic device 906 and/or the second electronic device 908) to provide haptic alert to one or more entities via one or more actuators integrated into the electronic devices 906, 908. In some embodiments, the response device 916 is a computing device capable of initiating safety procedures or measures by controlling one or more systems or structures, for example, but not limited to, gates, fences, windows, jammers, systems, and similar systems or structures associated and/or linked with the monitoring system 904 based on one or more signals/instructions received from the server 920 to prevent unauthorized intrusion by one or more intruders. For example, the response device 916 is configured to close the gates and/or windows of one or more buildings in the zone 902 when an unauthorized geofence entry and/or unauthorized presence of the entity 910 is detected within the zone 902. In some embodiment, the response device 916 is configured to notify one or more remote or external systems regarding the unauthorized presence and/or entry in the zone 902. The external systems include, but are not limited to, access control systems, alarm systems, safety systems, automation systems, or logging and audit systems.

The alarm 918 corresponds to any audio device capable of providing audio alerts to the one or more users of the monitoring system 904 based on the signal/instructions from the server 920. For example, the alarm 918 is configured to provide the audio alerts to security personnel associated with the monitoring system 904 when an unauthorized geofence entry and/or unauthorized presence of the entity 910 is detected within the zone 902. In some embodiments (not illustrated), the response device 916 includes the alarm 918. In some embodiments, depending upon the requirement of the user of the monitoring system 904, the monitoring system 104 includes more than one alarms 918 installed at different locations within or outside the zone 902.

Referring back to FIG. 9, the first electronic device 906 is configured to receive the credential authentication request from the monitoring system 904 in response to the occurrence of the triggering event, and, in response, transmit the response (for example, the encrypted identity credentials) to the monitoring system 904. Additionally, the second electronic device 908 is configured to receive the biometric authentication request from the monitoring system 904 and transmit the biometric data of the entity 910 to the monitoring system 904, in response to the biometric authentication request. The first electronic device 906 and the second electronic device 908 are wearable, mobile, or implantable devices that are worn, carried, attached to, or embedded within the corresponding entity 910. For example, the first electronic device 906 and the second electronic device 908 include, but are not limited to, smart watches, badges, tags, tokens, key fobs, wrist-worn devices, chest-mounted badges, integrated garment tags, smart glasses, cell phones, tablets, or any wearable, mobile, or implantable devices now known or developed in future. It would be appreciated by a person skilled in the art that the association between the entity 910 and the electronic devices 906, 908 is persistent, temporary, time-bounded, revocable, context-dependent, or session based, and is established, modified, or revoked depending upon the requirements of the system 900, for example, through user input, system policy, automated processes, or combinations thereof.

Although not shown, in some embodiments, the second electronic device 908 is omitted and the first electronic device 906 is configured to perform the functionality of both the first electronic device 906 and the second electronic device 908. For example, the first electronic device 906, in such embodiments, is configured to receive the credential authentication request and the biometric authentication request from the monitoring system 904 and transmit the encrypted identity credentials and the biometric data to the monitoring system 904 in response to the credential authentication request and the biometric authentication request, respectively.

The various components of the first electronic device 906 will now be described hereinafter with respect to FIG. 13. It should be appreciated by those of ordinary skill in the art that FIG. 13 depicts the first electronic device 906 in a simplified manner and a practical embodiment includes additional components and suitably configured logic to support known or conventional operating features that are not described in detail herein. Although the first electronic device 906 is illustrated and described to be implemented within a single communication device, it is contemplated that the one or more components of the first electronic device 906 are alternatively be implemented in a distributed computing environment.

Referring to FIG. 13, the first electronic device 906 includes, among other components, a first electronic device transceiver 1302, a first electronic device memory 1304, a first electronic device processor 1306, the tamper sensors 1308, and a first electronic device user interface 1310. The components of the first electronic device 906, including the first electronic device transceiver 1302, the first electronic device memory 1304, the first electronic device processor 1306, the tamper sensors 1308, and the first electronic device user interface 1310 cooperate with one another to enable operations of the first electronic device 906. Each component communicates with one another via a first electronic device local interface (not illustrated). The first electronic device local interface includes, but not limited to, one or more buses or other wired or wireless connections, as is known in the art. The first electronic device local interface includes additional elements, which are omitted for simplicity, such as controllers, buffers (caches), drivers, repeaters, and receivers, among many others, to enable communications. Further, the first electronic device local interface includes address, control, and/or data connections to enable appropriate communications among the aforementioned components.

As illustrated, the first electronic device 906 includes the first electronic device transceiver 1302 to transmit one or more signals and/or data to and receive one or more signals and/or data from the monitoring system 904 (as illustrated in FIG. 9). For example, the first electronic device transceiver 1302 is configured to receive the credential authentication request from the monitoring system 904, and, in response, transmit the encrypted identity credentials to the monitoring system 904. In some embodiments, the first electronic device transceiver 1302 is configured to transmit data and/or signals from the tamper sensors 1308 to the tamper detector 922 of the monitoring system 904. The first electronic device transceiver 1302 includes a transmitter circuitry and a receiver circuitry to enable the first electronic device 906 to communicate with the monitoring system 904. In this regard, the receiver circuitry includes appropriate circuitry to receive the credential authentication request from the monitoring system 904 and the transmitter circuitry includes appropriate circuitry to transmit the encrypted identity credentials to the monitoring system 904. It will be appreciated by those of ordinary skill in the art that the first electronic device 906 includes a single first electronic device transceiver 1302 as illustrated, or alternatively separate transmitting and receiving components, for example but not limited to, a transmitter, a transmitting antenna, a receiver, and a receiving antenna.

The first electronic device memory 1304 is a non-transitory memory configured to store a set of instructions that are executable by the first electronic device processor 1306 to perform predetermined operations. For example, the first electronic device memory 1304 includes any of the volatile memory elements (for example, random access memory (RAM)), non-volatile memory elements (for example, read only memory (ROM)), and combinations thereof. Moreover, the first electronic device memory 1304 incorporates electronic, magnetic, optical, and/or other types of storage media. In accordance with some embodiments, the first electronic device memory 1304 is configured to store the at least one key (for example, a private key) to encrypt the identity credentials of the entity 910 before transmitting the identity credentials to the monitoring system 904.

The first electronic device processor 1306 is configured to execute the instructions stored in the first electronic device memory 1304 to perform the predetermined operations. In accordance with various embodiments, the first electronic device processor 1306 is configured to generate the encrypted identity credentials of the entity 910 by encrypting the identity credentials of the entity 910 using the at least one key. The first electronic device processor 1306 is further configured to instruct the first electronic device transceiver 1302 to transmit the encrypted identity credentials to the monitoring system 904, for example, the server 920 of the monitoring system 904. In some embodiments, the first electronic device processor 1306 is configured to control the one or more tamper sensors 1308 to transmit the tamper data to the server 920 or the tamper detector 922 of the monitoring system 904.

The first electronic device processor 1306 includes one or more microprocessors, microcontrollers, DSPs (digital signal processors), state machines, logic circuitry, or any other device or devices that process information or signals based on operational or programming instructions. The first electronic device processor 1306 is implemented using one or more controller technologies, such as Application Specific Integrated Circuit (ASIC), Reduced Instruction Set Computing (RISC) technology, Complex Instruction Set Computing (CISC) technology, or any other similar technology now known or in the future developed. The first electronic device processor 1306 is configured to cooperate with other components of the first electronic device 906 to perform its operations (described in detail with reference to FIG. 15).

In accordance with various embodiments, the first electronic device user interface 1310 is configured to receive inputs from and/or provide the outputs to the entity 910. The inputs are provided via a touch screen display, a camera, a touch pad, a keyboard, a microphone, a recorder, a mouse, or any other user input mechanism now known or developed in the future. The outputs are provided via a display device, such as a display, a speaker, a haptic output, or any other output mechanism now known or developed in the future. The first electronic device user interface 1310 further includes a serial port, a parallel port, an infrared (IR) interface, a universal serial bus (USB) interface, and/or any other interface herein known or developed in the future. In some embodiments, the first electronic device user interface 1310 includes a graphical user interface (GUI) through which the user inputs his/her identity credentials. The GUI includes one or more of graphical elements including, but not limited to, one or more of dialogue boxes, window, web forms, and/or the like. The graphical elements are used in conjunction with text to prompt the user to enter his/her identity credentials in response to the credential authentication request received from the monitoring system 904. In some other embodiments, the identity credentials of the entity 910 is stored in the first electronic device memory 1304, for example, as a digital token and need not to be entered by the entity 910.

The tamper sensors 1308 are configured to capture the tamper data associated with the first electronic device 906 and provide the tamper data to the tamper detector 922 to detect the physical compromise of the first electronic device 906. The tamper sensors 1308 includes one or more of: the GSR sensor configured to measure skin conductance and generate the galvanic skin response (GSR) conductance signal, the clasp sensor configured to detect proximity of the clasp with a housing and generate the proximity state signal, the orientation sensor configured to measure an orientation and attitude of the first electronic device 906 and generate the orientation signal, the impact sensor configured to detect acceleration and generate the impact signal, the morphing material circuit configured to monitor strain in flexible substrate and generate the resistance/capacitance change signal, and other sensors for detecting the physical compromise of the first electronic device 906. It would be appreciated that the detection of the physical compromise of any electronic device using the tampers sensors 1308 is well known in the art, and hence the detailed functioning of these tamper sensors 1308 is not described here for the sake of brevity.

In some embodiments, the first electronic device 906 is configured to detect, via the first electronic device processor 1306 and the first electronic device transceiver 1302, the monitoring system 904 within a proximity of the first electronic device 106 when the first electronic device 906 enters the zone 902. In such cases, the monitoring system 904 is configured to broadcast, via the beacon 914, a beacon signal at regular intervals in the zone 902 and the first electronic device 906 is configured to perform a network scan to detect the beacon signal transmitted by the monitoring system 904. The first electronic device 906 is configured to detect the monitoring system 904 within the proximity of the first electronic device 906 upon detection of the beacon signal and transmit the encrypted identity credentials to the monitoring system 904 upon detection of the monitoring system 904 within the proximity of the first electronic device 906.

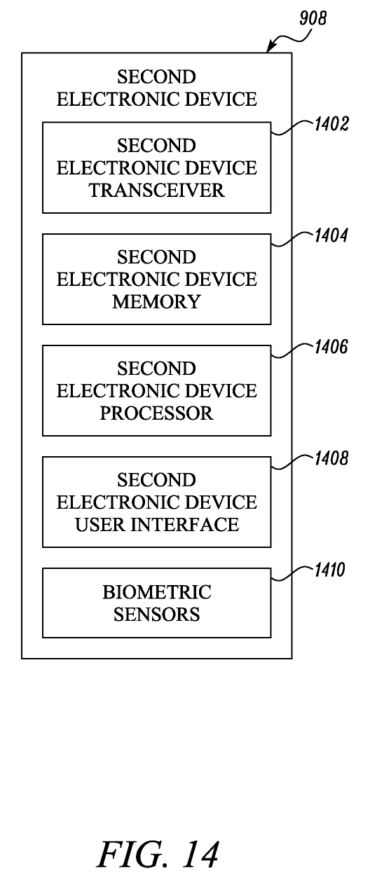

The various components of the second electronic device 908 will now be described hereinafter with respect to FIG. 14. It should be appreciated by those of ordinary skill in the art that FIG. 14 depicts the second electronic device 908 in a simplified manner and a practical embodiment includes additional components and suitably configured logic to support known or conventional operating features that are not described in detail herein. Although the second electronic device 908 is illustrated and described to be implemented within a single communication device, it is contemplated that the one or more components of the second electronic device 908 are alternatively be implemented in a distributed computing environment.

Referring to FIG. 14, the second electronic device 908 includes, among other components, a second electronic device transceiver 1402, a second electronic device memory 1404, a second electronic device processor 1406, and a second electronic device user interface 1408, and one or more biometric sensors 1410. The components of the second electronic device 908, including the second electronic device transceiver 1402, the second electronic device memory 1404, the second electronic device processor 1406, the second electronic device user interface 1408, and the biometric sensors 1410 cooperate with one another to enable operations of the second electronic device 908. Each component communicates with one another via a second electronic device local interface (not illustrated). The second electronic device local interface includes, but not limited to, one or more buses or other wired or wireless connections, as is known in the art. The second electronic device local interface includes additional elements, which are omitted for simplicity, such as controllers, buffers (caches), drivers, repeaters, and receivers, among many others, to enable communications. Further, the second electronic device local interface includes address, control, and/or data connections to enable appropriate communications among the aforementioned components.

As illustrated, the second electronic device 908 includes the second electronic device transceiver 1402 to transmit one or more signals and/or data to and receive one or more signals and/or data from the monitoring system 904 (as illustrated in FIG. 9). For example, the second electronic device transceiver 1402 is configured to receive the biometric authentication request from the monitoring system 904 and transmit the biometric data to the monitoring system 904 in response. The second electronic device transceiver 1402 includes a transmitter circuitry and a receiver circuitry to enable the second electronic device 908 to communicate with the monitoring system 904. In this regard, the transmitter circuitry includes appropriate receiver circuitry to receive the biometric authentication request from the monitoring system 904 and appropriate transmitter circuitry to transmit the biometric data to the monitoring system 904. It will be appreciated by those of ordinary skill in the art that the second electronic device 908 includes a single second electronic device transceiver 1402 as illustrated, or alternatively separate transmitting and receiving components, for example but not limited to, a transmitter, a transmitting antenna, a receiver, and a receiving antenna.

The second electronic device memory 1404 is a non-transitory memory configured to store a set of instructions that are executable by the second electronic device processor 1406 to perform predetermined operations. For example, the second electronic device memory 1404 includes any of the volatile memory elements (for example, random access memory (RAM)), non-volatile memory elements (for example, read only memory (ROM)), and combinations thereof. Moreover, the second electronic device memory 1404 incorporates electronic, magnetic, optical, and/or other types of storage media.

The second electronic device processor 1406 is configured to execute the instructions stored in the second electronic device memory 1404 to perform the predetermined operations. In accordance with various embodiments, the second electronic device processor 1406 is configured to capture the biometric data of the entity 910 in response to the biometric authentication request from the monitoring system 904, and instruct the second electronic device transceiver 1402 to transmit the biometric data to the monitoring system 904, for example, to the server 920 of the monitoring system 904. In accordance with various embodiments, the second electronic device processor 1406 is configured to capture the biometric data of the entity 910 using the biometric sensors 1410 integrated into or coupled to the second electronic device 908.

The second electronic device processor 1406 includes one or more microprocessors, microcontrollers, DSPs (digital signal processors), state machines, logic circuitry, or any other device or devices that process information or signals based on operational or programming instructions. The second electronic device processor 1406 is implemented using one or more controller technologies, such as Application Specific Integrated Circuit (ASIC), Reduced Instruction Set Computing (RISC) technology, Complex Instruction Set Computing (CISC) technology, or any other similar technology now known or in the future developed. The second electronic device processor 1406 is configured to cooperate with other components of the second electronic device 908 to perform its operations (described in detail with reference to FIG. 15).

In accordance with various embodiments, the second electronic device user interface 1408 is configured to receive inputs from and/or provide the outputs to the entity 910. For example, the second electronic device user interface 1408 includes a graphical user interface (GUI) to prompt the entity 910 to enter the biometric data. The inputs are provided via a touch screen display, a camera, a touch pad, a keyboard, a microphone, a recorder, a mouse, or any other user input mechanism now known or developed in the future. The outputs are provided via a display device, such as a display, a speaker, a haptic output, or any other output mechanism now known or developed in the future. The second electronic device user interface 1408 further includes a serial port, a parallel port, an infrared (IR) interface, a universal serial bus (USB) interface, and/or any other interface herein known or developed in the future. In some other embodiments (for example, when the entity 910 is a non-human entity), the second electronic device user interface 1408 is omitted and the biometric data is captured automatically by the biometric sensors 1410.

The biometric sensors 1410 are integrated into or coupled to the second electronic device 908 to capture the biometric data of the entity 910. For example, the biometric sensors 1410 include one or more of: fingerprint scanners, cameras, microphones, wearable electrodes, contact sensors, accelerometers, gyroscopes, pulse oximeters, and other sensors or devices now known or developed in future to capture the biometric data of the entity 910. The biometric sensors 1410 are configured to capture the biometric data of the entity 910 upon receiving the biometric authentication request and transmit the biometric data to the monitoring system 904, via the second electronic device transceiver 1402. It would be appreciated that the use of biometric sensors 1410 to capture the biometric data is well known in the art, and hence the detailed functioning of these biometric sensors 1410 is not described here for the sake of brevity.

Referring to FIG. 15, an exemplary method 1500 for authorizing the presence of the entity 910 in the zone 902 is illustrated and described. It would be appreciated by the person skilled in the art that although the method 1500 is described for authorizing the presence of one entity 910 within the zone 902, the same method 1500 is applicable for authorizing the presence of each entity of the plurality of entities 910-1, 910-2, 910-3 within the zone 902. The method 1500 begins, at 1502, with the monitoring system 904 detecting the occurrence of the triggering event associated with the entity 910. As discussed above, the triggering event includes one or more of: the geofence entry of the entity 910 within the zone 902, the input received on the first electronic device 906, or the expiration of the preset time interval for authorizing presence of the entity 910 in the zone 902.

In accordance with various embodiments, the detector 912 and the at least one processor (for example, the detector processor 134 of the detector 912 or the server processor 1106 of the server 920) is configured to detect the triggering event associated with the entity 910 in the zone 902. To detect the geofence entry of the entity 910 in the zone 902, the sensor 138 of the detector 912 monitors the physical area corresponding to the zone 902 and captures the data associated with the changes in the zone 902. For example, as described above, the data associated with the changes in the zone 902 includes one or more of: the temperature data, the visual image data, the thermal image data, or any other detection data associated with the zone 902. The detector processor 134 or the server processor 1106 obtains the data associated with the changes in the zone 902 and determines the geofence entry of the entity 910 in the zone 902 based on the obtained data (as described in detail above).

The detector processor 134 or the server processor 1106 further obtains the data regarding the preset time interval from the detector memory 136 or the server memory 1104 and computes the expiry time (as described above). The detector processor 134 or the server processor 1106 then periodically compares the expiry time with the current time, and determines the expiration of the preset time interval when the current time is greater than or equal to the expiry time. Furthermore, the detector processor 134 or the server processor 1106 detects the input received on the first electronic device 906 based on the network message received from the first electronic device 906. The detector processor 134 or the server processor 1106 is configured to detect the occurrence of the triggering event when the geofence entry of the entity 910 is detected in the zone 902, the present time interval expires, and/or the network message is received.

At 1504, the monitoring system 904 transmits the credential authentication request to the first electronic device 906 in response to the occurrence of the triggering event. In accordance with various embodiments, the beacon 914 and the at least one processor (for example, the beacon processor 148 of the beacon 914 or the server processor 1106 of the server 920) transmits the credential authentication request to the first electronic device 906 in response to the occurrence of the triggering event. For example, the beacon processor 148 or the server processor 1106, upon determining the occurrence of the triggering event, controls and/or instructs the beacon transceiver 144 to transmit the credential authentication request in the zone 902 to request the identity credentials of the first electronic device 906 (if any) in the zone 902.

In accordance with some embodiments, the first electronic device 906, upon receiving the credential authentication request, transmits encrypted identity credentials of the entity 910 as the response to the at least one processor (for example, the server processor 1106). For example, in an embodiment, the first electronic device processor 1306 of the first electronic device 906 obtains the identity credentials of the entity 910 from the first electronic device memory 1304. In some alternate embodiments, the first electronic device processor 1306 of the first electronic device 906 obtains the identity credentials of the entity 910 from the entity 910 via the first electronic device user interface 1310. The first electronic device processor 1306 further encrypts the identity credentials of the entity 910 using the at least one key stored in the first electronic device memory 1304 and instructs the first electronic device transceiver 1302 to transmit the encrypted identity credentials to the server processor 1106.

The server processor 1106, upon receiving the encrypted identity credentials, via the beacon 914 or the server transceiver 1102, decrypts the received encrypted identity credentials to obtain the identity credentials of the entity 910. The server processor 1106 then compares the obtained identity credentials of the entity 910 with one or more stored identity credentials in the server memory 1104. As described above, the one or more stored identity credentials corresponds to the identity credentials of one or more entities that are authorized to enter and/or be present in the zone 902 during the authorization time window. The server processor 1106 compares the obtained identity credentials of the entity 910 with the one or more stored identity credentials to determine whether the obtained identity credentials of the entity 910 is listed in the one or more stored identity credentials. When the obtained identity credentials of the entity 910 is listed in the one or more stored identity credentials, the server processor 1106 authenticates the first electronic device 906 associated with the entity 910. Additionally, in some embodiments, the server processor 1106 also compares the current time with the time indicated in the authorization time window corresponding to the entity 910 to determine whether the entity 910 is allowed to enter or be present in the zone 902 at that particular time. When the authorization time window includes the current time, the server processor 1106 authenticates the first electronic device 906 associated with the entity 910, for example, for the preset time interval.

At 1506, the monitoring system 904 periodically, for example, after every specified time period, determines the tamper status of the first electronic device 906 associated with the entity 910. In accordance with various embodiments, the tamper status of the first electronic device 906 is determined by the tamper detector 922 and the at least one processor of the monitoring system 904 (for example, the tamper detector processor 1006 of the tamper detector 922 or the server processor 1106 of the server 920). The tamper detector transceiver 1002 of the tamper detector 922 receives, for example, via the beacon 914, the tamper data from the tamper sensors 1308 installed in the first electronic device 906 and provides it to the tamper detector processor 1006 or the server processor 1106. The tamper detector processor 1006 or the server processor 1106 compares the tamper data with the one or more threshold values to determine the tamper status of the electronic device 906, using the process described above. The tamper detector processor 1006 or the server processor 1106 detects the occurrence of the tampering event at the first electronic device 906 when the tamper status of the first electronic device 906 is determined as compromised.

At 1508, the at least one processor of the monitoring system (for example, the server processor 1106) triggers the fallback authentication sequence to authorize the presence of the entity 910 in the zone 902. The fallback authentication sequence includes authentication of the first entity 910 using biometric data of the entity 910. In accordance with various embodiments, the server processor 1106 triggers the fallback authentication in absence of the response to the credential authentication request from the first electronic device 906 within the predetermined time interval or the failure to authenticate the first electronic device 906 based on the response to the credential authentication request or detection of the tampering event at the first electronic device 906 based on the tamper status.

At 1510, the at least one processor of the monitoring system (for example, the server processor 1106) instructs and/or controls the beacon 914 to transmit the biometric authentication request to the second electronic device 908 associated with the entity 910 as the fallback authentication sequence. Upon receiving the biometric authentication request, the second electronic device 908 captures the biometric data of the entity 910 using the biometric sensors 1410 and transmits the biometric data of the entity 910 to the monitoring system 904, using the process described above.

At 1512, the monitoring system 904, for example, the beacon 914 of the monitoring system 904, receives the biometric data from the second electronic device 908 and provides the received biometric data to the server processor 1106. At 1514, the server processor 1106 authenticates the second electronic device 908 of the entity 910 based on the received biometric data. For example, the server processor 1106 compares the received biometric data with the stored biometric data of the entity 910 in the server memory 1104 and authenticates the entity 910 and/or the second electronic device 908 of the entity 910 when the received biometric data matches the stored biometric data of the entity 910. When the received biometric data is different from the stored biometric data of the entity 910, the server processor 1106 determines the failure of the authentication of the entity 910 and/or the second electronic device 908 of the entity 910. Additionally, in some embodiments, the server processor 1106 also compares the current time with the time indicated in the authorization time window corresponding to the entity 910 to determine whether the entity 910 is allowed to enter or be present in the zone 902 at that particular time. When the authorization time window includes the current time, the server processor 1106 authenticates the entity 910 and/or the second electronic device 908 associated with the entity 910, for example, for the preset time interval.

At 1516, the monitoring system 904, for example, the server processor 1106, authorizes the presence of the entity 910 for the preset time interval upon the authentication. At 1518, the monitoring system 904 deactivates, via the at least one processor of the monitoring system 904 (for example, the server processor 1106), the response device 916 and/or the alarm 918 based on the authorization. In some embodiments, the monitoring system 904 authorizes the detected geofence entry and/or the presence of the entity 910 in the zone 902 and deactivates the response device 916 for the preset time interval. Alternatively, the monitoring system 904 activates the alarm 918 or the response device 916 when the geofence entry or presence of the entity 910 is not authorized. In some embodiments, the monitoring system 904 is configured to request the first electronic device 906 to reauthenticate itself upon the next or a subsequent occurrence of the triggering event after an initial triggering event. To this end, the method 1500 loops back to 1502 after the preset time interval. Alternatively, the first electronic device 906 is configured to reauthenticate itself after the preset time interval by providing the self-authentication data to the monitoring system 904 for self-authentication.

The system and the method of the present description is directed towards preventing unnecessary triggering of the alarm 118 or the response device 116 of the monitoring system 104 when the movement or presence of any authorized entity, such as a pet, a family member, or a vehicle, is detected in the zone 102. By broadcasting the first encrypted wireless signal in the zone 102 upon detection of the entity 110 in the zone 102 to authenticate the electronic device 106 and authorizing the detected movement of entities with authenticated electronic devices 106, the system and the method of the present description ensure proper authorization of the movement of such entities 110 within the zone 102. This prevents any needless and repeated triggering of the alarm 118 or the response device 116 of the monitoring system 104 for the authorized entities 110 without compromising the security within the zone 102.

Furthermore, the system and the method of the present description restrict access to the zone 902 to the authorized entities 910 and enforces their individual authorization time windows to prevent unauthorized entry or overstays. Moreover, the biometric identification of the entity 910 in case of certain scenarios (defined above), ensures security of the zone 902 even when the electronic device 906 associated with the entity 910 is compromised or stolen. Furthermore, periodic transmission of the credential authentication request after expiration of the preset time interval and periodic determination of the occurrence of the tampering event, verify the continued presence and identity of the entity 910 thereby maintaining the security of the zone 902.

In the hereinbefore specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that can cause any benefit, advantage, or solution to occur or become more pronounced are not to be construed as a critical, required, or essential feature or elements of any or all the claims. The invention is defined solely by the appended claims including any amendments made during the pendency of this application and all equivalents of those claims as issued.

Moreover, in this document, relational terms such as first and second, top and bottom, and the like are used solely to distinguish one entity or action from another entity or action without necessarily requiring or implying any actual such relationship or order between such entities or actions. The terms "comprises," "comprising," “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but includes other elements not expressly listed or inherent to such process, method, article, or apparatus. An element preceded by “comprises …a”, “has …a”, “includes …a”, “contains …a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but also be configured in ways that are not listed.

It will be appreciated that some embodiments are comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (example, comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

1. A system for authorizing presence of at least one entity in at least one zone, the system comprising:
at least one monitoring system comprising at least one detector, at least one beacon, and at least one tamper detector communicatively coupled to each other, wherein the at least one monitoring system is configured to:
detect, via the at least one detector and at least one processor of the at least one monitoring system, an occurrence of a triggering event associated with the at least one entity and transmit, via the at least one beacon and the at least one processor, a credential authentication request in response to the occurrence of the triggering event,
wherein the triggering event comprises one or more of: a geofence entry of the at least one entity within the at least one zone, an input received on a first electronic device associated with the at least one entity, or an expiration of a preset time interval for authorizing presence of the at least one entity in the at least one zone,
periodically determine, via the at least one tamper detector and the at least one processor, tamper status of the first electronic device associated with the at least one entity,
in absence of a response to the credential authentication request from the first electronic device within a predetermined time interval or a failure to authenticate the first electronic device based on a response to the credential authentication request or detection of a tampering event at the first electronic device based on the tamper status, trigger, via the at least one processor, a fallback authentication sequence to authorize the presence of the at least one entity in the at least one zone,
transmit, via the at least one beacon, a biometric authentication request as the fallback authentication sequence to authorize the presence of the at least one entity in the at least one zone; and
at least one second electronic device associated with the at least one entity, the at least one second electronic device configured to:
receive, via a transceiver, the biometric authentication request from the at least one monitoring system;
obtain, via a user interface and a processor, biometric data of the at least one entity in response to the biometric authentication request; and
transmit, via the transceiver, the biometric data of the at least one entity to the at least one monitoring system,
wherein the at least one monitoring system further comprises a response device, and is configured to:
receive, via the beacon, the biometric data of the at least one entity,
authenticate, via the at least one processor, the at least one entity based on the received biometric data,
authorize, via the at least one processor, the presence of the at least one entity for the preset time interval upon the authentication, and
deactivate, via the at least one processor, the response device based on the authorization.

2. The system of claim 1, wherein the at least one detector includes at least one sensor for detecting the geofence entry of the at least one entity within the at least one zone.

3. The system of claim 1, wherein the at least one tamper detector is configured to determine the tamper status of the first electronic device based on tamper data received from at least one tamper sensor in the first electronic device.

4. The system of claim 3, wherein the at least one tamper sensor corresponds to one or more of: a bio-signal sensor for detecting galvanic skin response (GSR) of the at least one entity, a proximity sensor for detecting an engagement state of a clasp of the first electronic device, an orientation sensor for detecting an orientation of the first electronic device, an impact sensor for detecting an impact experienced by the first electronic device, and an electronic circuit for detecting changes in morphing or flexible material integrated in the first electronic device.

5. The system of claim 1, wherein the biometric data includes one or more of: fingerprints, facial scans, voice pattern, vein pattern, electrocardiogram signatures, iris pattern, skin impedance, gait signatures, and oxygenation profiles.

6. The system of claim 1, wherein the at least one monitoring system includes at least one of: a plurality of drones and a plurality of robotic ground units deployed in the at least one zone, and further wherein one or more components of the at least one detector, the at least one beacon, the at least one tamper detector, and the at least one processor are integrated within at least one drone of the plurality of drone or at least one robotic ground unit of the plurality of robotic ground units.

7. The system of claim 1, wherein the at least one monitoring system further includes an adaptive behavior module including an artificial intelligence engine configured to monitor behavior patterns of the at least one entity and dynamically adjust the triggering event, the tampering event, and the fallback authentication sequence in response to anomalies in the monitored behavior patterns.

8. The system of claim 1, wherein the at least one monitoring system is configured to:
receive, via the at least one beacon, encrypted identity credentials of the first electronic device in response to the credential authentication request.

9. The system of claim 1, wherein the at least one monitoring system includes a server user interface of a server to enable a user to define the triggering event and the tampering event.

10. The system of claim 1, wherein the at least one monitoring system includes a storage device to store data associated with the triggering event, the tampering event, and the fallback authentication sequence, wherein the storage unit corresponds to one or more of: a cloud server, an on-site storage device, or a decentralized blockchain ledger.

11. The system of claim 1, wherein the first electronic device corresponds to a wearable device.

12. The system of claim 1, wherein the at least one monitoring system is configured to activate the response device upon non-receipt of the biometric data within the predefined time interval or a failure of the authentication of the at least one entity based on the received biometric data.

13. The system of claim 1, wherein the at least monitoring system is configured to deactivate the response device for the preset time interval.

14. A method for authorizing presence of at least one entity in at least one zone, the method comprising:
detecting, via at least one detector and at least one processor of at least one monitoring system, an occurrence of a triggering event associated with the at least one entity and transmit, via at least one beacon and the at least one processor of the at least one monitoring system, a credential authentication request in response to the occurrence of the triggering event,
wherein the triggering event comprises one or more of: a geofence entry of the at least one entity within the at least one zone, an input received on a first electronic device associated with the at least one entity, or an expiration of a preset time interval for authorizing presence of the at least one entity in the at least one zone;
periodically determining, via at least one tamper detector and the at least one processor of the at least one monitoring system, tamper status of the first electronic device associated with the at least one entity;
in absence of a response to the credential authentication request from the first electronic device within a predetermined time interval or a failure to authenticate the first electronic device based on a response to the credential authentication request or detection of a tampering event at the first electronic device based on the tamper status, triggering, via the at least one processor, a fallback authentication sequence to authorize the presence of the at least one entity in the at least one zone;
transmitting, via the at least one beacon, a biometric authentication request as the fallback authentication sequence to authorize the presence of the at least one entity in the at least one zone;
receiving, via a transceiver of at least one second electronic device associated with the at least one entity, the biometric authentication request from the at least one monitoring system;
obtaining, via a user interface and a processor of the at least one second electronic device, biometric data of the at least one entity in response to the biometric authentication request;
transmitting, via the transceiver of the at least one second electronic device, the biometric data of the at least one entity to the at least one monitoring system;
receiving, via the beacon, the biometric data of the at least one entity;
authenticating, via the at least one processor, the at least one entity based on the received biometric data;
authorizing, via the at least one processor, the presence of the at least one entity for the preset time interval upon the authentication; and
deactivating, via the at least one processor, a response device of the at least one monitoring system based on the authorization.

15. The method of claim 14, further comprising:
detecting, via at least one sensor of the at least one detector, the geofence entry of the at least one entity within the at least one zone.

16. The method of claim 14, further comprising:
determining, by the at least one tamper detector, the tamper status of the first electronic device based on tamper data received from at least one tamper sensor in the first electronic device.

17. The method of claim 16, wherein the at least one tamper sensor corresponds to one or more of: a bio-signal sensor for detecting galvanic skin response (GSR) of the at least one entity, a proximity sensor for detecting an engagement state of a clasp of the first electronic device, an orientation sensor for detecting an orientation of the first electronic device, an impact sensor for detecting an impact experienced by the first electronic device, and an electronic circuit for detecting changes in morphing or flexible material integrated in the first electronic device.

18. The method of claim 14, further comprising:
monitoring, by an adaptive behavior module of the at least one monitoring system, behavior patterns of the at least one entity and dynamically adjusting the triggering event, the tampering event, and the fallback authentication sequence in response to anomalies in the monitored behavior patterns.

19. The method of claim 14, further comprising:
activating, via the at least one processor, the response device upon non-receipt of the biometric data within the predefined time interval or a failure of the authentication of the at least one entity based on the received biometric data.

20. The method of claim 14, further comprising:
deactivating, via the at least one processor, the response device for the preset time interval.
